(19) United States
(12) Patent Application Publication
(10) Pub. No.: US 2025/0182298 A1
(43) Pub. Date: Jun. 5, 2025

(54) MOVING IMAGE DATA ACQUISITION DEVICE, MOVING IMAGE DATA ACQUISITION SYSTEM, AND VIBRATION MEASUREMENT METHOD

(71) Applicant: MITSUBISHI HEAVY INDUSTRIES, LTD., Tokyo (JP)

(72) Inventors: Akihisa IWASAKI, Tokyo (JP); Naoki GOTO, Tokyo (JP)

(73) Assignee: MITSUBISHI HEAVY INDUSTRIES, LTD., Tokyo (JP)

(21) Appl. No.: 18/843,995

(22) PCT Filed: Mar. 9, 2023
(86) PCT No.: PCT/JP2023/009064

§ 371 Date: Sep. 4, 2024

(30) Foreign Application Priority Data
Mar. 9, 2022 (JP) 2022-036543

(51) Int. Cl. G06T 7/246; B64U 70/90; G03B 15/00; H04N 23/68

(52) U.S. Cl. CPC G06T 7/246; B64U 70/90; G03B 15/006; H04N 23/683; B64U 2201/10; B64U 2201/20; G06T 2207/10016; G06T 2207/10032; H04N 23/6812

(57) ABSTRACT

A moving image data acquisition device includes a camera, a support that supports the camera, and a coupling member that couples the support and the camera, wherein the coupling member has a natural vibration frequency in a vibration frequency region lower than a vibration frequency region serving as a measurement target for vibration measurement using moving image data acquired by the camera.

### TECHNICAL FIELD

The present disclosure relates to a moving image data acquisition device, a moving image data acquisition system, and a vibration measurement method.

This application claims priority based on Japanese Patent Application No. 2022-036543, filed in Japan on Mar. 9, 2022, the contents of which are incorporated herein by reference.

### BACKGROUND ART

Patent Document 1 describes a measurement device that measures the vibration of a building serving as a measurement target based on each frame image of a moving image captured by a camera (imaging device) included in a mobile body.

The measurement device described in Patent Document 1 includes an acquisition unit, a removal unit, and a measurement unit.

The acquisition unit acquires a moving image of one or a plurality of buildings captured by the camera included in the mobile body.

The removal unit removes, from the moving image acquired by the acquisition unit, a movement component representing the movement of the camera and a vibration component caused by the camera that correspond to a spatiotemporal frequency band different from a spatiotemporal frequency of the vibration of a predetermined building.

The measurement unit measures the vibration of the one or plurality of buildings based on each frame image of the moving image from which the movement component and the vibration component have been removed by the removal unit.

### CITATION LIST

### Patent Document

Patent Document 1: JP 2018-136191 A

### SUMMARY OF INVENTION

### Technical Problem

However, in the measurement device described in Patent Document 1, for example, when the spatiotemporal frequency band of the vibration of the measurement target overlaps the frequency bands of the movement component indicating the movement of the camera and the vibration component caused by the camera, there is a problem in that the vibration of the measurement target cannot be appropriately measured.

The present disclosure has been made to solve the above problem, and an object thereof is to provide a moving image data acquisition device, a moving image data acquisition system, and a vibration measurement method that enable appropriate measurement of a vibration based on a moving image captured by a camera.

### Solution to Problem

In order to solve the above problem, a moving image data acquisition device according to the present disclosure includes a camera, a support that supports the camera, and a coupling member that couples the support and the camera, wherein the coupling member has a natural vibration frequency in a vibration frequency region lower than a vibration frequency region serving as a measurement target for vibration measurement using moving image data acquired by the camera.

A moving image data acquisition system according to the present disclosure includes an unmanned aerial vehicle equipped with a camera, and a landing platform on which the unmanned aerial vehicle is capable of being landed, wherein the landing platform is disposed such that a vibration measurement target is included in a coverage area of the camera when the unmanned aerial vehicle is landed.

### Advantageous Effects of Invention

According to a moving image data acquisition device, a moving image data acquisition system, and a vibration measurement method of the present disclosure, it is possible to appropriately measure a vibration based on a moving image captured by a camera.

### BRIEF DESCRIPTION OF DRAWINGS

FIG. 1 is a schematic diagram illustrating a configuration example of a moving image data acquisition system according to a first embodiment of the present disclosure.

FIG. 2 is a schematic diagram illustrating an example of a vibration model of a moving image data acquisition device according to the first embodiment of the present disclosure.

FIG. 3 is a schematic diagram showing an example of response characteristics of the vibration model illustrated in FIG. 2.

FIG. 4 is a schematic diagram illustrating an example of an image captured by the moving image data acquisition device according to the first embodiment of the present disclosure.

FIG. 5 is a schematic diagram showing an example of frequency characteristics of a vibration measured based on a moving image captured by the moving image data acquisition device according to the first embodiment of the present disclosure.

FIG. 6 is a schematic diagram illustrating a comparative example of the moving image data acquisition device according to the first embodiment of the present disclosure.

FIG. 7 is a schematic diagram showing an example of frequency characteristics of a vibration measured based on a moving image captured by the comparative example of the moving image data acquisition device according to the first embodiment of the present disclosure.

FIG. 8 is a schematic diagram illustrating a configuration example of a moving image data acquisition device according to a second embodiment of the present disclosure.

FIG. 9 is a schematic diagram illustrating a configuration example of the moving image data acquisition device according to the second embodiment of the present disclosure.

FIG. 10 is a schematic diagram illustrating a configuration example of a moving image data acquisition device according to the second embodiment of the present disclosure.

FIG. 11 is a schematic diagram illustrating a configuration example of the moving image data acquisition device according to the second embodiment of the present disclosure.

FIG. 12 is a schematic diagram illustrating a configuration example of a moving image data acquisition device according to the second embodiment of the present disclosure.

FIG. 13 is a schematic diagram illustrating a configuration example of a moving image data acquisition device according to a third embodiment of the present disclosure.

FIG. 14 is a schematic diagram illustrating a configuration example of a moving image data acquisition device according to the third embodiment of the present disclosure.

FIG. 15 is a schematic diagram showing an example of frequency characteristics of a vibration measured based on a moving image captured by each moving image data acquisition device according to the third embodiment of the present disclosure.

FIG. 16 is a schematic diagram illustrating configuration examples of moving image data acquisition devices according to a fourth embodiment of the present disclosure.

FIG. 17 is a schematic diagram illustrating a configuration example of a moving image data acquisition device according to a fifth embodiment of the present disclosure.

FIG. 18 is a schematic diagram illustrating a configuration example of the moving image data acquisition device according to the fifth embodiment of the present disclosure.

FIG. 19 is a schematic diagram illustrating a configuration example of a moving image data acquisition device according to the fifth embodiment of the present disclosure.

FIG. 20 is a schematic diagram illustrating a configuration example of a moving image data acquisition device according to the fifth embodiment of the present disclosure.

FIG. 21 is a schematic diagram illustrating a configuration example of a moving image data acquisition system according to each of sixth and seventh embodiments of the present disclosure.

FIG. 22 is a schematic diagram illustrating an example of an image captured by the moving image data acquisition device according to each of the sixth and seventh embodiments of the present disclosure.

FIG. 23 is a flowchart illustrating an operation example of the moving image data acquisition system according to each of the sixth and seventh embodiments of the present disclosure.

FIG. 24 is a schematic diagram illustrating a configuration example of a moving image data acquisition system according to an eighth embodiment of the present disclosure.

FIG. 25 is a schematic diagram illustrating a configuration example of a moving image data acquisition system according to a ninth embodiment of the present disclosure.

FIG. 26 is a flowchart illustrating an operation example of the moving image data acquisition system according to the ninth embodiment of the present disclosure.

FIG. 27 is a schematic diagram for describing the moving image data acquisition system according to the ninth embodiment of the present disclosure.

FIG. 28 is a schematic diagram illustrating an example of an image captured by a moving image data acquisition device according to the ninth embodiment of the present disclosure.

FIG. 29 is a schematic diagram showing an example of frequency characteristics of a vibration measured based on a moving image captured by the moving image data acquisition system according to the ninth embodiment of the present disclosure.

FIG. 30 is a schematic diagram illustrating a configuration example of a moving image data acquisition device according to a tenth embodiment of the present disclosure.

FIG. 31 is a schematic diagram illustrating a configuration example of a moving image data acquisition system according to each of eleventh and twelfth embodiments of the present disclosure.

FIG. 32 is a schematic diagram illustrating an example of an image captured by a moving image data acquisition device according to each of the eleventh and twelfth embodiments of the present disclosure. 30 FIG. 33 is a schematic diagram illustrating a configuration example of a moving image data acquisition system according to a thirteenth embodiment of the present disclosure.

FIG. 34 is a schematic diagram for describing a modification example of the moving image data acquisition system according to each of the ninth to thirteenth embodiments of the present disclosure.

FIG. 35 is a schematic diagram for describing a modification example of the moving image data acquisition system according to each of the ninth to thirteenth embodiments of the present disclosure.

FIG. 36 is a schematic block diagram illustrating a configuration of a computer according to at least one embodiment.

FIG. 37 is a schematic diagram illustrating a configuration example of a moving image data acquisition device according to a modification example of the first embodiment of the present disclosure.

FIG. 38 is a schematic diagram illustrating a configuration example of a moving image data acquisition device according to a modification example of the first embodiment of the present disclosure.

FIG. 39 is a schematic diagram illustrating a configuration example of a moving image data acquisition device according to a modification example of the first embodiment of the present disclosure.

FIG. 40 is a schematic diagram illustrating a configuration example of a moving image data acquisition device according to a modification example of the ninth embodiment of the present disclosure.

### DESCRIPTION OF EMBODIMENTS

Hereinafter, a moving image data acquisition device, a moving image data acquisition system, and a vibration measurement method according to each embodiment of the present disclosure will be described with reference to the drawings.

Note that, in the drawings, the same or corresponding components are denoted by the same reference signs, and the description thereof will be appropriately omitted.

### First Embodiment

### Configuration and Operation

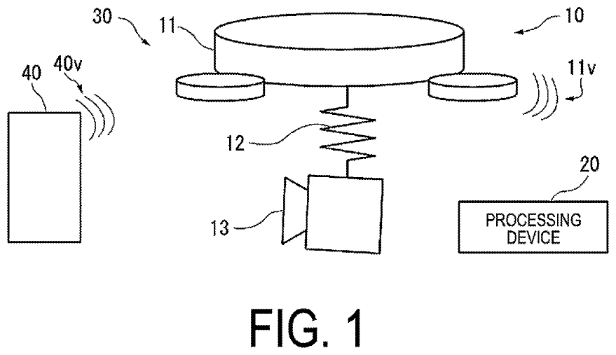

Hereinafter, a moving image data acquisition device, a moving image data acquisition system, and a vibration measurement method according to a first embodiment of the present disclosure will be described with reference to FIGS. 1 to 7.

FIG. 1 is a schematic diagram illustrating a configuration example of the moving image data acquisition system according to the first embodiment of the present disclosure.

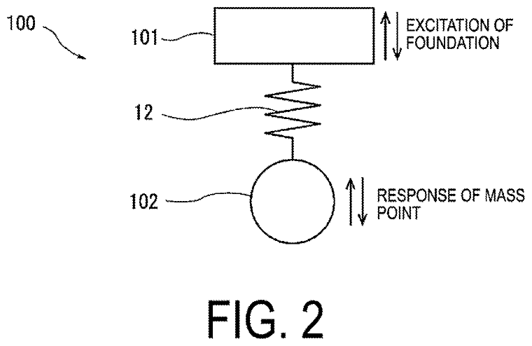

FIG. 2 is a schematic diagram illustrating an example of a vibration model of the moving image data acquisition device according to the first embodiment of the present disclosure.

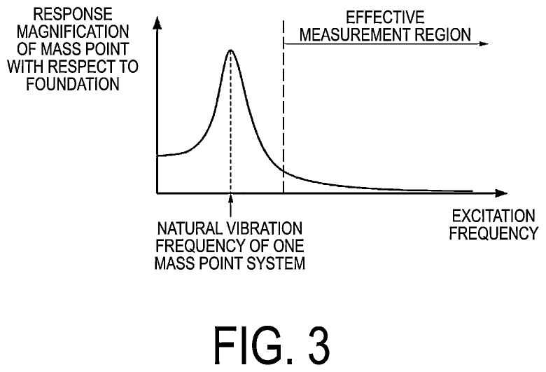

FIG. 3 is a schematic diagram showing an example of response characteristics of the vibration model illustrated in FIG. 2.

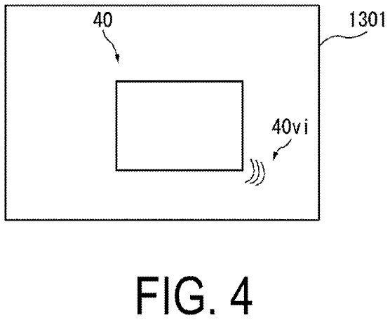

FIG. 4 is a schematic diagram illustrating an example of an image captured by the moving image data acquisition device according to the first embodiment of the present disclosure.

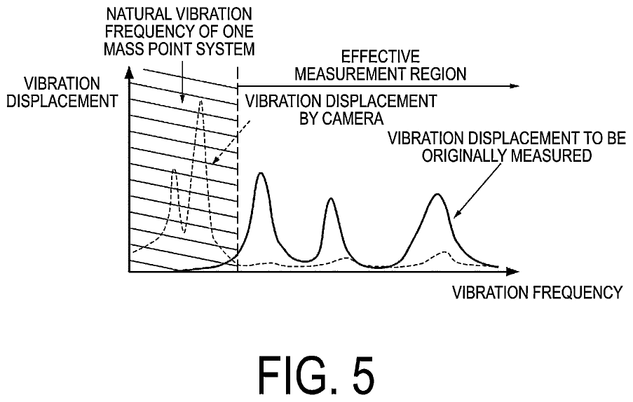

FIG. 5 is a schematic diagram showing an example of frequency characteristics of a vibration measured based on a moving image captured by the moving image data acquisition device according to the first embodiment of the present disclosure.

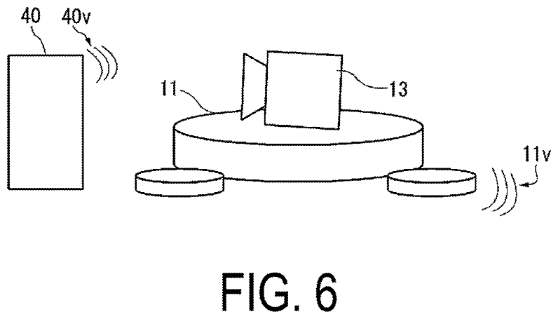

FIG. 6 is a schematic diagram illustrating a comparative example of the moving image data acquisition device according to the first embodiment of the present disclosure.

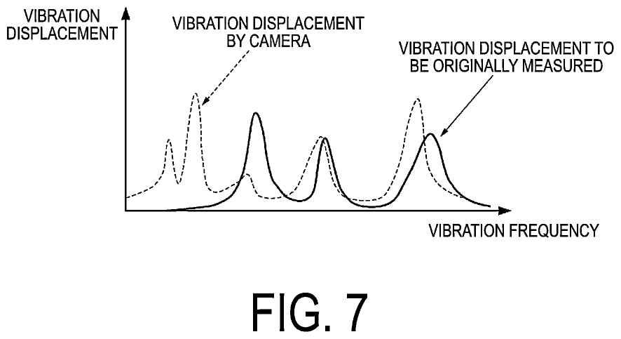

FIG. 7 is a schematic diagram showing an example of frequency characteristics of a vibration measured based on a moving image captured by the comparative example of the moving image data acquisition device according to the first embodiment of the present disclosure.

A moving image data acquisition system 30 illustrated in FIG. 1 includes a moving image data acquisition device 10 and a processing device 20.

The moving image data acquisition system 30 illustrated in FIG. 1 measures the vibration of a measurement target 40 based on moving image data acquired by the moving image data acquisition device 10 and including the measurement target 40 as a subject.

The measurement target 40 is a target of the vibration measurement based on the moving image data.

The measurement target 40 is, for example, an object the weight of which is supported on or which is installed on a ground, a foundation, or the like, wherein the vibration of the object, which is changed due to aging deterioration, accidental anomaly, or the like, can be measured from the appearance. Alternatively, the measurement target 40 is, for example, a certain peripheral region including the object.

Examples of the measurement target 40 include a structure such as a building or a bridge, a machine serving as an excitation source such as a compressor, a pump, a motor, or a fan in a plant, and a peripheral object vibrated, accompanied by the excitation source.

However, the measurement target 40 is not limited to these examples.

Note that FIG. 1 schematically illustrates a vibration 40v of the measurement target 40 and a vibration 11v of a drone 11.

The moving image data acquisition device 10 includes the drone 11, a spring 12, and a camera 13.

The camera 13 is coupled by the spring 12 to the drone 11 supporting the camera 13.

In the present embodiment, the drone 11 is an example of a support that supports the camera 13.

The spring 12 is an example of a coupling member that couples the drone 11 and the camera 13.

Note that, in FIG. 1, the camera 13 is coupled by the spring 12 in a state of being suspended below the drone 11, but no such limitation is intended.

For example, the camera 13 may be coupled by the spring 12 in a state of being mounted above the drone 11.

In addition, the moving image data acquisition device 10 (the drone 11 or the camera 13) may have some or all of the functions of the processing device 20 described below.

The drone 11 is an unmanned aerial vehicle, includes a motor, a propeller, a control device, an imaging device, a wireless communication device, and the like, and flies by remote control or automatic control.

The spring 12 is a buffer element, and stores and releases energy through elastic deformation to absorb a shock and vibration.

The spring 12 includes one or a plurality of springs.

The natural vibration frequency of the spring 12 is determined by the spring constant and a mass placed on or suspended by the spring.

Note that the material and shape of the spring 12 are not limited.

The spring 12 may be made of, for example, metal, non-metal, rubber, air, or liquid, or may have a shape of a coil spring, leaf spring, torsion spring, or the like.

In the present embodiment, the spring constant of the spring 12 is adjusted such that the spring 12 has a natural vibration frequency in a vibration frequency region lower than a vibration frequency region to be measured in the vibration measurement using the moving image data acquired by the camera 13.

Note that the spring 12 may be attached to the drone 11 via, for example, a pair of slide mechanisms.

The pair of slide mechanisms include, for example, a buffer element in a sliding direction, and slides the spring 12 in front-rear and left-right directions within a certain range.

By providing the pair of slide mechanisms, it is possible to suppress the influence of the high-frequency component of the vibration from the spring 12 to the camera 13.

In the present embodiment, the spring 12 has frequency characteristics that attenuate a vibration in the vibration frequency region to be measured in the vibration measurement using the moving image data.

FIG. 2 illustrates a vibration model 100 corresponding to the moving image data acquisition device 10.

The vibration model 100 is a model of one-mass-point system, and a mass point 102 corresponding to the camera 13 is suspended by the spring 12 from a foundation 101 corresponding to the drone 11.

Note that, in FIG. 2, illustration of a damping system (damper) is omitted.

FIG. 3 shows the relationship between an excitation frequency and a response magnification. In FIG. 3, the horizontal axis represents the excitation frequency of the foundation 101 and the vertical axis represents the response magnification of the mass point 102 with respect to the foundation 101.

The response magnification is the magnification of the vibration displacement of the mass point 102 with respect to the excitation displacement of the foundation 101.

The response magnification is maximum at the natural vibration frequency of the one-mass-point system and decreases as the vibration frequency is away from the natural vibration frequency.

In the present embodiment, a vibration frequency region in which the response magnification is equal to or less than a predetermined value is defined as an effective measurement region.

In the effective measurement region, the vibration is isolated by the spring 12.

In the effective measurement region, the vibration displacement of the measurement target 40 can be measured while the influence of the vibration displacement of the camera 13 having the drone 11 as the excitation source is suppressed to be lower than that outside the effective measurement region.

The spring constant of the spring 12 is adjusted such that the effective measurement region includes the vibration frequency region to be measured.

The camera 13 is an imaging device that captures and records a moving image.

The camera 13 includes an optical system such as a lens, an imaging element, a signal processing device, a recording device, a communication device, and the like.

The camera 13 may further include an adjustment mechanism of an imaging direction (or a rotation mechanism), a distance measuring device, and the like.

In this case, it is desirable that the adjustment mechanism (or the rotation mechanism) can be remotely operated.

The imaging operation of the camera 13 can be remotely controlled by the processing device 20.

The camera 13 records a captured moving image in the recording device or transmits the captured moving image to the processing device 20 using the communication device.

Note that the camera 13 may be a monocular camera or a compound-eye camera such as a stereo camera.

The camera 13 may include a plurality of monocular cameras or the like having a fixed positional relationship.

The imaging direction of the camera 13 may be one direction, a plurality of directions, or all directions.

The camera 13 may be a visible-light camera, an infrared camera, or the like.

The camera 13 may be configured using, for example, a mobile terminal having a camera function.

In addition, the camera 13 may have a function of measuring the distance to the measurement target 40 based on a captured image or using a distance measuring device or the like and recording the distance in association with the moving image.

The processing device 20 acquires moving image data acquired by the moving image data acquisition device 10 and including the measurement target 40 as a subject from the moving image data acquisition device 10 in a wired or wireless manner or via a recording medium.

Then, the processing device 20 measures a vibration 40vi of the measurement target 40 based on moving image data 1301 acquired by the moving image data acquisition device 10 and including the measurement target 40 as a subject as illustrated in FIG. 4.

Note that the vibration 40vi included in the moving image data 1301 includes a noise component with respect to the vibration 40v of the measurement target 40 illustrated in FIG. 1.

In addition, the vibration measured by the processing device 20 can be, for example, the displacement, velocity, and acceleration of a vibration with one translational component, two translational components, or three translational components, the displacement, velocity, and acceleration of a vibration with six degrees of freedom of three translational components and three rotational components, or the like.

The processing device 20 measures the vibration of the measurement target 40 using an existing technology as described in, for example, Patent Document 1.

The processing device 20 measures the vibration, for example, as follows.

The processing device 20 performs, for example, image recognition processing such as pattern matching and identifies a region corresponding to the measurement target 40 included in the moving image data.

Further, the processing device 20 tracks feature points and feature regions based on, for example, a plurality of frames of image data included in the moving image data, and acquires data representing the translation movement of the positions of the feature points and feature regions, a change in size or distortion, a rotation angle around an optical axis, and the like.

The processing device 20 calculates the displacement vector of the measurement target 40 based on the result of identifying the region corresponding to the measurement target 40, the result of extracting and tracking the feature points or feature regions, and information such as the imaging distance, the focal length, and the specifications of the imaging element.

Note that the processing device 20 may extract only a vibration frequency component corresponding to the effective measurement region from the calculated displacement vector.

Alternatively, the processing device 20 may perform processing of removing data corresponding to a component outside the effective measurement region from the data obtained as the result of tracking.

FIG. 5 schematically shows a vibration measurement result by the processing device 20.

The horizontal axis represents the vibration frequency, and the vertical axis represents the vibration displacement.

A broken line indicates the vibration displacement by the camera 13, and a solid line indicates the vibration displacement 40v to be originally measured.

The vibration displacement by the camera 13 has a large value in the peripheral region of the natural vibration frequency of the one-mass-point system indicated by hatching and is suppressed to be small in the effective measurement region.

In the effective measurement region, the influence of the vibration of the camera 13 can be suppressed to be small, and the vibration of the measurement target 40 can be accurately measured.

On the other hand, for example, when the camera 13 is directly mounted on the drone 11 as illustrated in FIG. 6, the vibration measurement result obtained from the moving image data is, for example, as illustrated in FIG. 7.

In FIG. 7, the horizontal axis represents the vibration frequency, and the vertical axis represents the vibration displacement, in a manner similar to FIG. 5. A broken line indicates the vibration displacement by the camera 13, and a solid line indicates the vibration displacement 40v to be originally measured.

In the measurement result illustrated in FIG. 7, as compared with the example illustrated in FIG. 5, the vibration displacement of the measurement target 40 and the relatively large vibration displacement of the camera 13 overlap each other in many vibration frequency regions.

### Action, Effect and Supplementary Explanation

In the first embodiment, the drone 11 and the camera 13 are coupled to each other using the spring 12 having a spring constant adjusted such that the spring 12 has a natural vibration frequency in the vibration frequency region lower than the vibration frequency region to be measured. Thus, the vibration can be appropriately measured based on the moving image captured by the camera.

According to the present embodiment, the camera is structured to be supported by the spring, and the vibration can be evaluated with a specific noise removed.

The vibration by the drone may be transmitted to the camera in a wide vibration frequency range.

Examples of the vibration of the drone include a low-frequency vibration during flying, a mechanical vibration when the propeller is rotating, and the like.

The influence of these vibrations appears in the image data as a camera shake. For removal of the camera shake, it is necessary to remove the camera shake in a wide vibration frequency range. However, the vibration of the target to be originally checked is in the same vibration frequency range and thus cannot be distinguished.

Thus, in the present embodiment, the camera is defined as the mass of the one-mass-point system and is supported by the spring, whereby the behavior of the camera is a response of the one-mass-point system, and a vibration frequency range higher than the natural vibration frequency thereof is a region in which the vibration is not transmitted and is isolated.

By setting the vibration frequency of the measurement target in the region (by sufficiently reducing the natural vibration frequency of the camera and the spring), the influence from the drone is reduced, and only the vibration component of the measurement target to be originally measured can be checked.

The camera is configured as the one-mass-point system by using the spring, and the camera is intentionally vibrated largely at the natural vibration frequency thereof, but the vibration can be made very small in a vibration frequency region larger than the natural vibration frequency.

In the vibration frequency region larger than the natural vibration frequency, the vibration components of the drone and the camera are almost insulated.

Thus, in the vibration frequency region, the vibration can be evaluated without being affected by the vibration of the camera.

In addition, by deviating a specific frequency component close to the natural vibration frequency from the frequency to be measured, it is possible to eliminate the specific frequency component at the time of analysis.

That is, by clarifying the main vibration component of the moving image capturing camera, the vibration component can be easily eliminated by a filter at the time of analysis.

According to the present embodiment, it is possible to eliminate the influence of the vibration of the drone from the image captured by the drone and appropriately analyze the vibration.

Note that, in another embodiment, a plurality of camera-equipped drones may be used as a stereo camera to perform measurement.

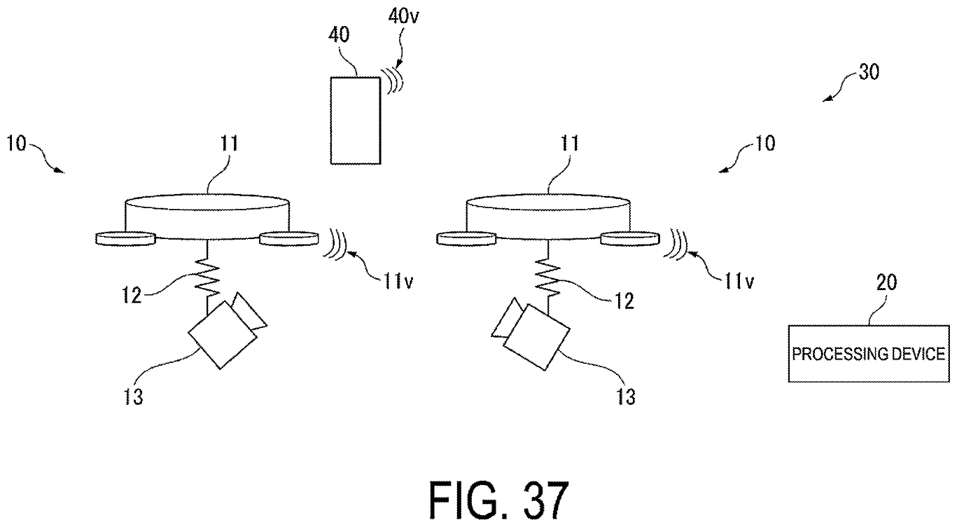

That is, as illustrated in FIG. 37, a moving image data acquisition system 30 according to another embodiment may include a plurality of (for example, two) moving image data acquisition devices 10 each equipped with one camera 13.

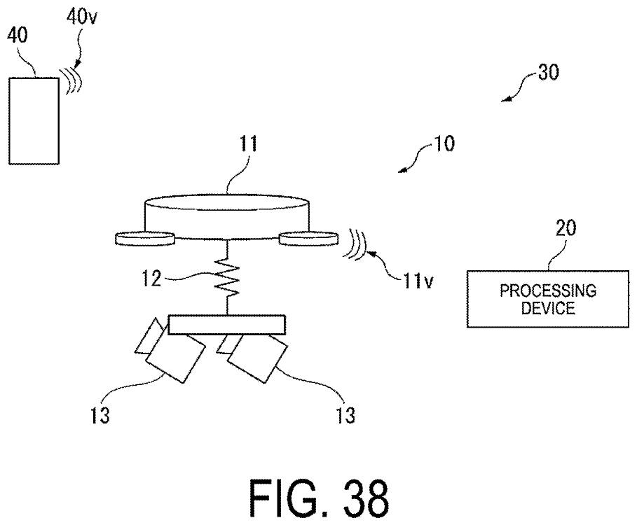

As illustrated in FIG. 38, a moving image data acquisition system 30 according to another embodiment may have an aspect in which one moving image data acquisition device 10 is equipped with a plurality of (for example, two) cameras 13.

By adopting the aspect as illustrated in FIG. 37 or FIG. 38, the plurality of cameras 13 images a measurement target 40 from different angles, and thus three-dimensional (XYZ) vibration displacement analysis can be performed.

In the embodiments described above, the drone 11 has the vibration isolation mechanism (spring 12) for the camera 13. However, the vibration isolation mechanism is designed to prevent the vibration of the drone 11 at the “time of imaging” from being transmitted to the camera 13.

Thus, in a time period other than the “time of imaging” (for example, during flight from the base to the target to be imaged), there is a concern that the vibration of the camera 13 is rather increased by providing the vibration isolation mechanism.

Thus, in another embodiment, a moving image data acquisition device 10 may have a function of fixing a camera 13 such that the camera 13 does not largely vibrate in a time period other than a time of measurement (imaging).

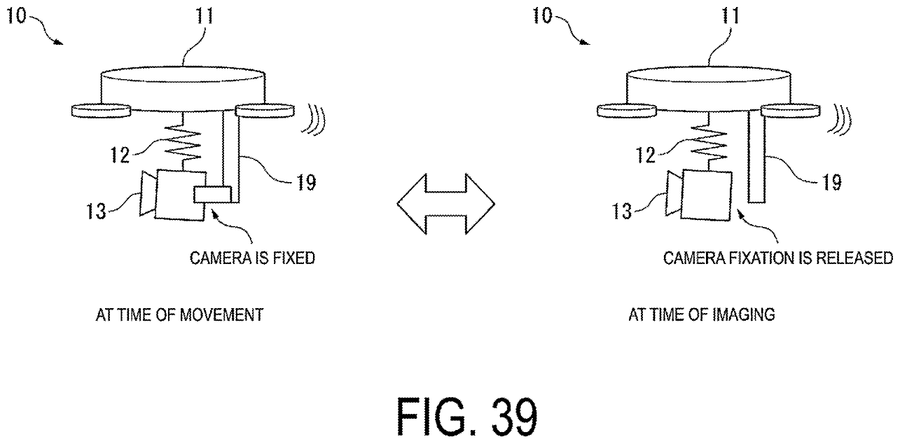

A specific configuration example is as illustrated in FIG. 39.

That is, the moving image data acquisition device 10 further includes a camera fixing member 19, in addition to the configuration according to the first embodiment.

The camera fixing member 19 is made of a rigid material and is fixed to a main body of a drone 11.

The camera fixing member 19 holds and fixes the camera 13 such that the relative position between the camera 13 and the drone 11 does not change in a time period other than the time of imaging (for example, a time of movement) (left diagram of FIG. 39).

In addition, the camera fixing member 19 releases the fixation of the camera 13 while the camera 13 is capturing an image (right diagram of FIG. 39).

In this way, it is possible to prevent the camera 13 from largely vibrating and being damaged in a time period other than the “time of imaging” (for example, a time period during movement).

### Second Embodiment

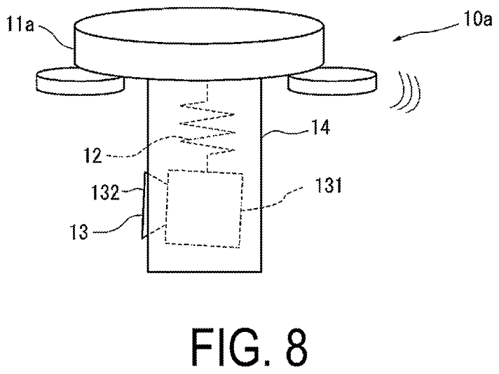

Next, moving image data acquisition devices according to a second embodiment of the present disclosure will be described with reference to FIGS. 8 to 12.

FIGS. 8 to 12 are schematic diagrams illustrating configuration examples of the moving image data acquisition devices according to the second embodiment of the present disclosure.

The second embodiment is different from the first embodiment in the configuration of each moving image data acquisition device.

However, the basic configuration of the moving image data acquisition system 30 described with reference to FIG. 1 is the same between the first embodiment and the second embodiment.

As illustrated in FIG. 8, a moving image data acquisition device 10a of the second embodiment includes a drone 11a, a spring 12, and a camera 13.

The drone 11a includes a windbreak tube 14 (hereinafter referred to as a tube 14).

The tube 14 is detachably fixed to the drone 11a, for example.

For example, the camera 13 is supported such that an entire main body 131 and a part of a lens 132 are located inside the tube 14.

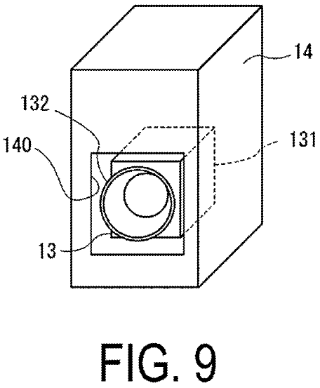

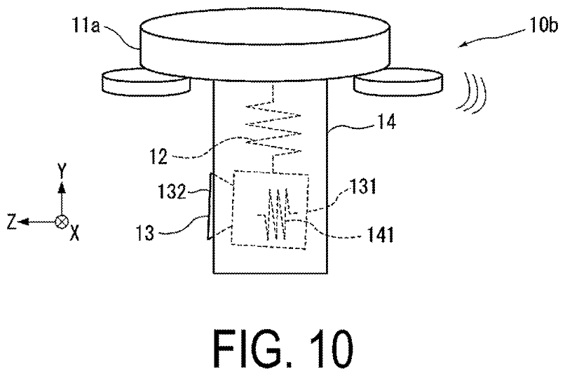

As illustrated in FIG. 9, the tube 14 includes a hole 140 through which the lens 132 of the camera 13 passes, and the camera 13 is supported such that a part or entirety of the lens 132 is located outside the tube 14 through the hole 140.

Note that, in FIG. 8, the camera 13 is coupled by the spring 12 in a state of being suspended below the drone 11a, but no such limitation is intended.

For example, the camera 13 may be coupled by the spring 12 in a state of being mounted above the drone 11a.

In this case, the tube 14 is also mounted above the drone 11a.

Further, the camera 13 may be supported such that the entire lens 132 is located inside the tube 14 as long as the inner wall of the tube 14 can be configured not to interfere with imaging.

Note that the shape of the tube 14 can be freely determined.

For example, the tube 14 may be a cylindrical tube or a square tube.

In addition, the hole 140 does not need to be provided, for example, when the front surface of the lens 132 is covered with a highly transparent material.

Alternatively, the entire tube 14 may be made of a transparent material such as glass.

In this case, the surface facing the lens 132 is desirably flat so as not to have curvature, for example.

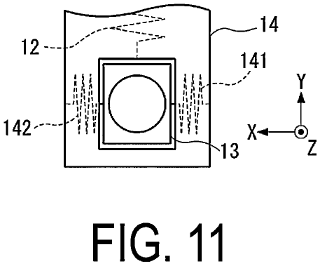

As illustrated in FIGS. 10 and 11, the camera 13 and the inner wall of the tube 14 may be connected by a plurality of connection members 141 and 142 having a natural vibration frequency in a vibration frequency region lower than a vibration frequency region to be measured.

A moving image data acquisition device 10b illustrated in FIGS. 10 and 11 further includes the connection members 141 and 142 as compared with the moving image data acquisition device 10a illustrated in FIG. 8.

The connection members 141 and 142 are, for example, springs.

The connection members 141 and 142 connect the left and right sides of the main body 131 of the camera 13 to the inner wall of the tube 14.

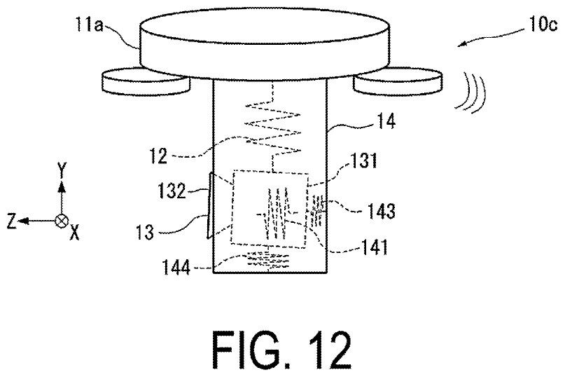

As illustrated in FIG. 12, the camera 13 and the inner wall of the tube 14 may be connected by a plurality of connection members 141, 142, 143, and 144 having a natural vibration frequency in a vibration frequency region lower than a vibration frequency region to be measured.

A moving image data acquisition device 10c illustrated in FIG. 12 further includes the connection members 143 and 144 as compared with the moving image data acquisition device 10b illustrated in FIGS. 10 and 11.

The connection members 143 and 144 are, for example, springs.

The connection members 143 and 144 connect the rear portion and the bottom portion of the main body 131 of the camera 13 to the inner wall of the tube 14.

According to the present embodiment, since the windbreak is attached, a vibration due to wind can be reduced, and a vibration due to a disturbance such as wind can be reduced.

In addition, it is easy to subsequently remove a vibration frequency that peaks at the natural vibration frequency.

In addition, by installing the spring in the horizontal direction or the like, it is possible to further reduce a vibration due to a disturbance such as wind or subsequently easily remove a vibration frequency that peaks at the natural vibration frequency.

As described above, according to the present embodiment, a vibration due to a disturbance in the horizontal direction, or the like can be reduced, and the effective measurement range can be clarified by removing a low-frequency peak.

Further, by providing the hole 140 and protruding the lens 132 to the outside of the tube 14, the tube 14 can be easily miniaturized even when, for example, the long lens 132 is used.

Note that, as a modification example of the second embodiment, a configuration may be adopted in which the tube 14 is not provided, an attachment member instead of the tube 14 is provided, and the connection members 141 to 144 and the like are provided.

### Third Embodiment

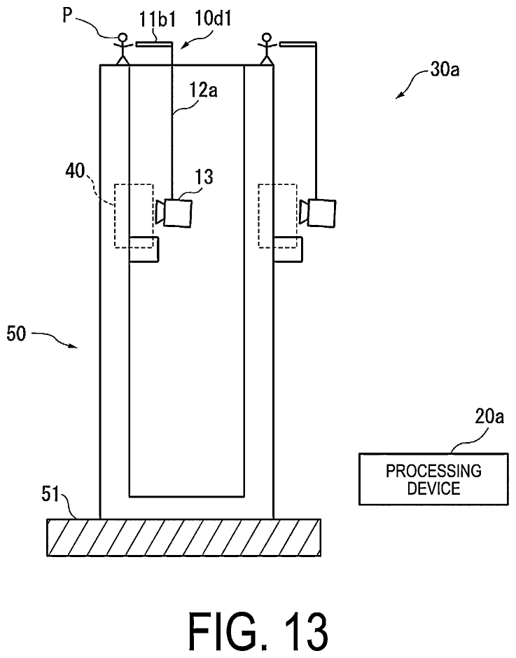

Moving image data acquisition devices, a moving image data acquisition system, and a vibration measurement method according to a third embodiment of the present disclosure will be described with reference to FIGS. 13 to 15.

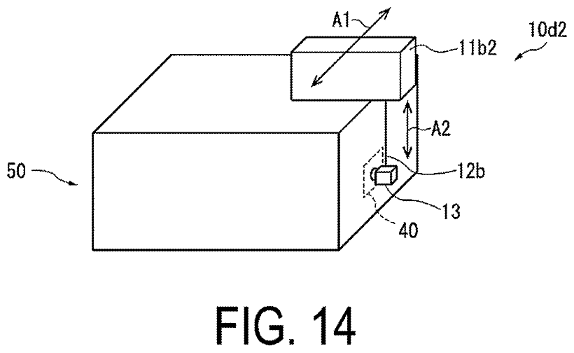

FIGS. 13 and 14 are schematic diagrams illustrating configuration examples of the moving image data acquisition devices according to the third embodiment of the present disclosure.

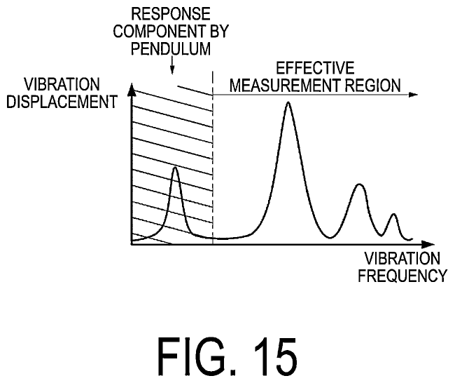

FIG. 15 is a schematic diagram showing an example of frequency characteristics of a vibration measured based on a moving image captured by each moving image data acquisition device according to the third embodiment of the present disclosure.

A moving image data acquisition system 30a of the present embodiment illustrated in FIG. 13 includes a moving image data acquisition device 10d1 and a processing device 20a.

The moving image data acquisition system 30a illustrated in FIG. 13 measures the vibration of a measurement target 40 based on moving image data acquired by the moving image data acquisition device 10d1 and including the measurement target 40 as a subject.

In the case illustrated in FIG. 13, the measurement target 40 is a wall surface or the like of a structural body 50 the weight of which is supported on a foundation 51.

The moving image data acquisition device 10d1 includes a rod-like member 11b1 that can be held by a person P, a wire 12a, and a camera 13.

The camera 13 is coupled by the wire 12a to the rod-like member 11b1 supporting the camera 13.

In the present embodiment, the rod-like member 11b1 is an example of a support that supports the camera 13.

The wire 12a is an example of a coupling member that couples the rod-like member 11b1 and the camera 13.

Note that, in the present embodiment, the camera 13 desirably includes a rotation mechanism for adjusting the angle with respect to the target.

Alternatively, the moving image data acquisition system 30a of the present embodiment may include a moving image data acquisition device 10d2 illustrated in FIG. 14, instead of the moving image data acquisition device 10d1.

The moving image data acquisition device 10d2 illustrated in FIG. 14 includes a wire winding device 11b2 fixed to a structural body 50, a wire 12a, and a camera 13.

The camera 13 is coupled by the wire 12b to the wire winding device 11b2 supporting the camera 13.

In the present embodiment, the wire winding device 11b2 is an example of a support that supports the camera 13.

The wire 12b is an example of a coupling member that couples the wire winding device 11b2 and the camera 13.

Note that the wire winding device 11b2 may be movable in a horizontal direction A1.

The wire winding device 11b2 adjusts the length of the wire 12b in a vertical direction A2.

The moving image data acquisition devices 10d1 and 10d2 of the present embodiment have a simple pendulum structure (or a hanging structure).

The rod-like member 11b1 and the wire winding device 11b2 correspond to a fixed point or a fixed axis of the simple pendulum structure.

The wires 12a and 12b correspond to a string of the simple pendulum structure.

The camera 13 corresponds to a weight of the simple pendulum structure.

Note that the length of each of the wires 12a and 12b is adjusted such that each of the wires 12a and 12b has a natural vibration frequency in a vibration frequency region lower than a vibration frequency region to be measured.

The processing device 20a has a configuration corresponding to the processing device 20 of the first embodiment. The processing device 20a measures the vibration of the measurement target 40 based on the moving image data captured by the camera 13 and including the measurement target 40 as a subject.

FIG. 15 is a schematic diagram showing an example of frequency characteristics of a vibration measured based on the moving image captured by each moving image data acquisition device according to the third embodiment of the present disclosure.

In FIG. 15, the vibration displacement of the measurement target 40 is indicated by a solid line. The horizontal axis represents the vibration frequency, and the vertical axis represents the vibration displacement.

In the hatched region, a response component by the pendulum is dominant.

The response component by the pendulum peaks at the natural vibration frequency of the pendulum structure.

A region having a vibration frequency higher than the hatched region is an insulation region in which the vibration is hardly transmitted.

In the insulation region, for example, the vibration from the structural body 50 serving as an excitation source for the camera 13 is insulated from the camera 13.

The processing device 20a measures the vibration of the measurement target 40 with a region having a higher frequency than the hatched region as an effective measurement region.

A way to perform the vibration measurement is basically the same between the processing device 20a and the processing device 20 of the first embodiment.

In the present embodiment, the hanging structure enables an image to be captured at an appropriate distance from the measurement target to some extent, and enables image measurement in which the image can be used as vibration data.

Note that the camera 13 may have some or all of the functions of the processing device 20a.

Alternatively, the processing device 20a may be configured integrally with the rod-like member 11b1 or the wire winding device 11b2.

### Fourth Embodiment

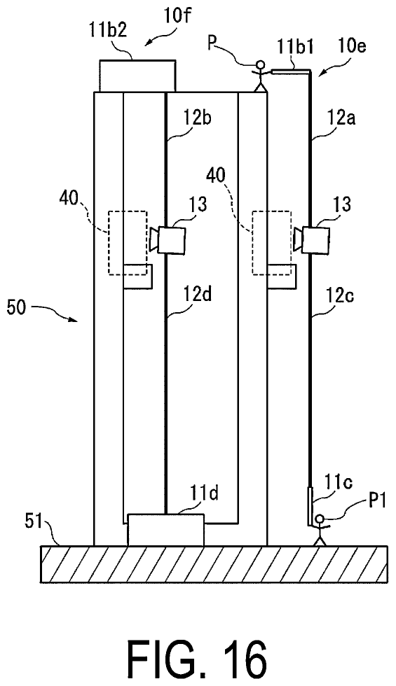

Moving image data acquisition devices according to a fourth embodiment of the present disclosure will be described with reference to FIG. 16.

FIG. 16 is a schematic diagram illustrating configuration examples of the moving image data acquisition devices according to the fourth embodiment of the present disclosure.

A moving image data acquisition device 10e according to the fourth embodiment illustrated in FIG. 16 further includes a wire 12c and a rod-like member 11c that can be held by a person P1, as compared with the moving image data acquisition device 10d1 according to the third embodiment illustrated in FIG. 13.

A camera 13 is coupled by the wire 12c, which is an example of a coupling member, to the rod-like member 11c, which is an example of a support that supports the camera 13.

A moving image data acquisition device 10f according to the fourth embodiment illustrated in FIG. 16 further includes a wire 12d and a wire winding device 11d, as compared with the moving image data acquisition device 10d2 according to the third embodiment illustrated in FIG. 14.

A camera 13 is coupled by the wire 12d, which is an example of a coupling member, to the wire winding device 11d, which is an example of a support that supports the camera 13.

In the present embodiment, the person can adjust the position from below or adjust the degree of pulling so as to suppress a shake.

Alternatively, in the present embodiment, by using the wire winding device, it is possible to adjust the position from below or adjust the degree of pulling so as to suppress a shake.

Further, the natural vibration frequency can be changed by adjusting the degree of pulling.

According to the present embodiment, the shake can be suppressed as compared with the third embodiment.

Note that, in a modification example of the present embodiment, for example, a camera moving wire may be permanently provided, and the position of a camera may be automatically adjusted or the camera may be moved to a fixed point in a state where the wire is stretched to some extent.

Further, in the present embodiment, vibration analysis is performed based on an image acquired by the hanging structure.

### Fifth Embodiment

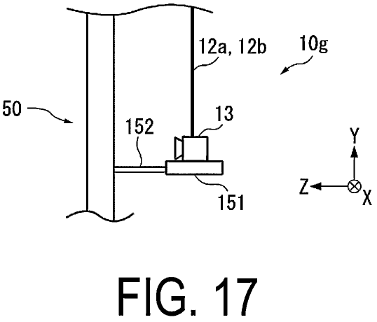

Moving image data acquisition devices according to a fifth embodiment of the present disclosure will be described with reference to FIGS. 17 to 20.

FIGS. 17 to 20 are schematic diagrams illustrating configuration examples of the moving image data acquisition devices according to the fifth embodiment of the present disclosure.

Moving image data acquisition devices 10g, 10h, and 10i of the present embodiment are different from the moving image data acquisition device 10d1 or 10d2 of the third embodiment or the moving image data acquisition device 10e or 10f of the fourth embodiment in the following points.

That is, the moving image data acquisition devices 10g, 10h, and 10i of the present embodiment are different in that a camera 13 is further provided with a prop extending to a wall or the like of a structural body 50 serving as a target such that the camera 13 is not too close to the structural body 50.

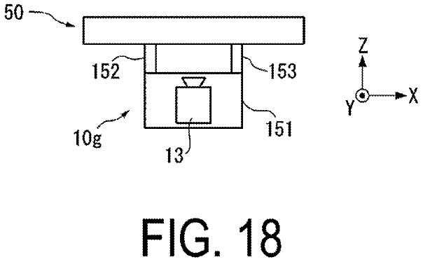

In the moving image data acquisition device 10g illustrated in FIGS. 17 and 18, a base plate 151 on which the camera 13 is mounted is provided with two props 152 and 153.

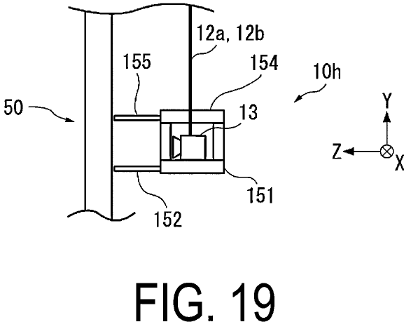

In addition, in the moving image data acquisition device 10h illustrated in FIG. 19, a frame is further configured using a flat plate 154, as compared with the moving image data acquisition device 10g, and the flat plate 154 is provided with a prop 155 and a prop (not illustrated) in a manner similar to the props 152 and 153.

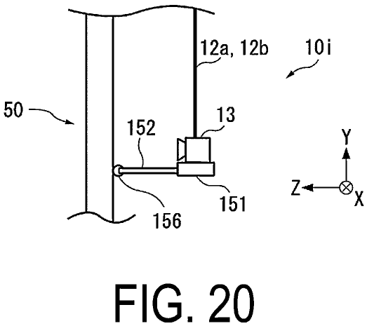

In addition, a moving image data acquisition device 10j illustrated in FIG. 20 includes a mechanism enabling smooth movement, such as a tire 156, at the distal end of a prop 152, and the like such that the moving image data acquisition device can move smoothly on the wall.

According to the present embodiment, the distance to the target (measurement target 40) can be maintained at a certain value or more.

### Sixth Embodiment

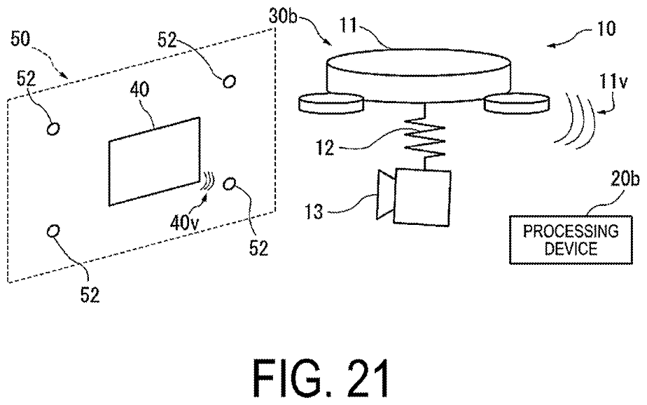

A moving image data acquisition device, a moving image data acquisition system, and a vibration measurement method according to a sixth embodiment of the present disclosure will be described with reference to FIGS. 21 to 23.

FIG. 21 is a schematic diagram illustrating a configuration example of each of the moving image data acquisition system according to the sixth embodiment of the present disclosure and a moving image data acquisition system according to a seventh embodiment of the present disclosure.

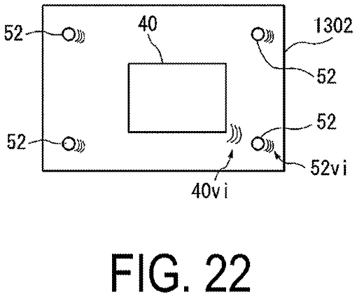

FIG. 22 is a schematic diagram illustrating an example of an image captured by each of the moving image data acquisition device according to the sixth embodiment of the present disclosure and a moving image data acquisition device according to the seventh embodiment of the present disclosure.

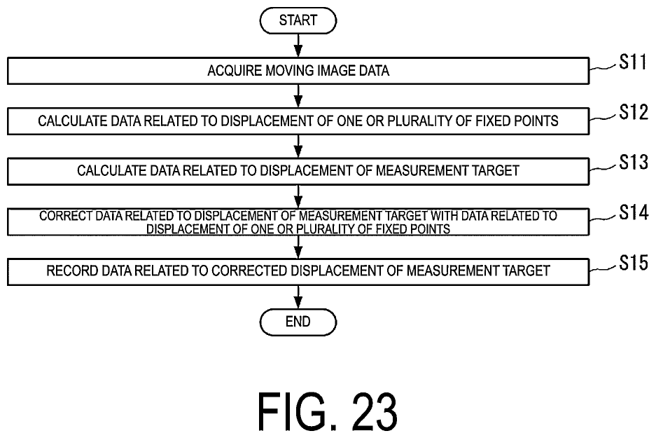

FIG. 23 is a flowchart illustrating an operation example of the moving image data acquisition system according to each of the sixth and seventh embodiments of the present disclosure.

The sixth embodiment is characterized in that the measurement accuracy of the vibration measurement in the first to fifth embodiments is improved.

In the sixth embodiment, for example, a point that can be regarded as a fixed point is set in image data, data of a measurement target is corrected by calculating the relative displacement between the fixed point and the measurement target, and the influence of a camera vibration is removed.

A moving image data acquisition system 30b illustrated in FIG. 21 includes a moving image data acquisition device 10 and a processing device 20b.

The processing device 20b corresponds to the processing device 20 illustrated in FIG. 1.

The moving image data acquisition system 30b illustrated in FIG. 21 measures the vibration of a measurement target 40 based on moving image data acquired by the moving image data acquisition device 10 and including the measurement target 40 and fixed points 52 as subjects.

At this time, the processing device 20b calculates data related to the displacement of one or a plurality of the fixed points 52 based on the moving image data.

The processing device 20b also calculates data related to the displacement of the measurement target 40 based on the moving image data.

In addition, the processing device 20b corrects the data related to the displacement of the measurement target 40 with the data related to the displacement of the one or plurality of fixed point 52.

Here, the data related to the displacement is data such as the displacement, velocity, and acceleration of the vibration included in the vibration measurement result.

Each fixed point 52 is a point or a region on an object that can be regarded as being fixed.

The expression “ . . . can be regarded as being fixed” means that the object vibrates only to an extent that can be ignored for ensuring of required accuracy in measurement of a vibration 40v of the measurement target 40.

Each fixed point 52 can be, for example, a pillar, a ground, a floor pattern, or a white line away from the measurement target 40 in a factory.

Each fixed point 52 may be set in advance around the measurement target 40 by a person, may be selected and set on the image by a person viewing the moving image data, or may be automatically set by the processing device 20b based on the moving image data.

In the case of automatic setting, for example, the processing device 20b randomly extracts a plurality of feature points from the moving image data and measures vibrations.

Next, the processing device 20b relatively compares the measured vibrations.

For example, when there are a plurality of feature points that are not included in the measurement target 40 and that have similar vibrations, the processing device 20b can set some or all of the feature points as fixed points.

FIG. 22 illustrates an example of moving image data 1302 acquired by the moving image data acquisition device 10 and including the measurement target 40 and the fixed points 52 as subjects in the present embodiment.

The moving image data 1302 includes information corresponding to a vibration 40vi, which is a vibration 40v of the measurement target 40 including a noise component, and a vibration 52vi of each fixed point 52 due to the noise component.

The vibration 52vi of each fixed point 52 due to the noise component mainly corresponds to the vibration of the camera 13.

That is, each fixed point 52 appears to vibrate in the image measurement due to the influence of the vibration of the camera 13.

FIG. 23 illustrates an operation example of each of the processing device 20b of the sixth embodiment and a processing device 20b of the below-described seventh embodiment.

The processing device 20b first acquires moving image data to be processed (step S11).

Next, the processing device 20b calculates data related to the displacement of the one or plurality of fixed points 52 based on the moving image data (step S12).

Next, the processing device 20b calculates data related to the displacement of the measurement target 40 based on the moving image data (step S13).

Next, the processing device 20b corrects the data related to the displacement of the measurement target 40 with the data related to the displacement of the one or plurality of fixed points 52 (step S14).

Next, the processing device 20b records data related to the corrected displacement of the measurement target (step S15).

In the present embodiment, the processing device 20b corrects the data related to the displacement of the measurement target 40 with the data related to the displacement of the one or plurality of fixed point 52 in step S14 as follows.

The influence of the vibration of the camera 13 is removed from the measurement result [x1, y1] of the measurement target 40 using the vibration [x, y] of each fixed point (reference point) 52.

The measurement result of the measurement target from which the influence of the camera vibration has been removed is defined as [x2, y2].

$$[ x 2 , y 2 ] = [ x 1 - x , y 1 - y ]$$

When the number of the fixed points is one, the above equation is satisfied. However, when the number of the fixed points is plural, the calculation is performed for each fixed point, and the results are slightly different (the results do not completely match because of an error).

In this case, the calculation is performed using the average value so that the error is minimized.

Alternatively, when the depth positions of each fixed point and the measurement target are significantly different from each other, a depth error also occurs. Thus, the position of each fixed point is corrected such that the depth positions of the measurement target and each fixed point are substantially the same.

As described above, according to the present embodiment, the data of the measurement target is corrected by calculating the relative displacement between each fixed point and the measurement target. Thus, the influence of the camera vibration can be removed, and the measurement accuracy of the vibration can be improved.

### Seventh Embodiment

The moving image data acquisition device, the moving image data acquisition system, and a vibration measurement method according to the seventh embodiment of the present disclosure will be described.

The seventh embodiment is partially different from the sixth embodiment in the content of step S14 in FIG. 23.

That is, in the present embodiment, the processing device 20b corrects data related to the displacement of a measurement target 40 with data related to the displacement of fixed points 52 in step S14 as follows.

As described above, each fixed point (reference point) appears to vibrate in image measurement due to the influence of the vibration of the camera 13.

The camera 13 vibrates with six degrees of freedom [X] of [x, y, z, θx, θy, θz], and thus each fixed point appears to vibrate similarly.

The relationship of the displacement of each fixed point with respect to the vibration of the camera 13 is measured or calculated in advance, and a 6×2 matrix [M] is calculated (considering the influence in the depth direction).

The vibration of the camera 13 can be expressed by the following equation from the vibration [x, y] of each fixed point.

[x,y]′=[M][X]

Thus, the vibration of the camera itself can be estimated from the measurement result of each fixed point by the following equation.

$$[ X ] = [ M ] - 1 [ x , y ] ’$$

This is performed at one point or a plurality of points.

When the number of points is plural, [X] does not completely match, but [X] is derived by the least squares method or the like so that an error is minimized.

By using [M] at the position of the measurement target and the vibration [X] of the camera for removal from the measurement result of the measurement target, the influence of the vibration of the camera can be removed.

In the present embodiment, the data of the measurement target is also corrected by calculating the relative displacement between each fixed point and the measurement target, in a manner similar to the sixth embodiment. Thus, the influence of the camera vibration can be removed, and the measurement accuracy of the vibration can be improved.

### Eighth Embodiment

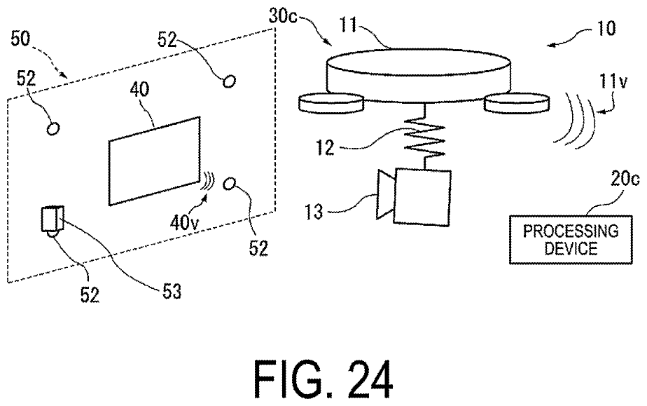

A moving image data acquisition device, a moving image data acquisition system, and a vibration measurement method according to an eighth embodiment of the present disclosure will be described with reference to FIG. 24.

The eighth embodiment is different from the sixth embodiment in that an accelerometer 53 is installed at a fixed point 52 as illustrated in FIG. 24 and in the content of processing in which a processing device 20c corrects data related to the displacement of a measurement target 40 with data related to the displacement of the fixed point 52.

The processing device 20c performs a step of correcting the data related to the displacement of the measurement target 40 with the data related to the displacement of the fixed point 52 and acceleration data measured by the accelerometer 53 at the fixed point 52.

As illustrated in FIG. 24, a moving image data acquisition system 30c of the present embodiment includes a moving image data acquisition device 10, a processing device 20c, and one or a plurality of accelerometers 53.

The one or plurality of accelerometers 53 may be installed at one or a plurality of fixed points 52.

The acceleration data measured by the one or plurality of accelerometers 53 is recorded in, for example, a predetermined recording device in the processing device 20c in a state where the acceleration data can be synchronized with moving image data acquired by the moving image data acquisition device 10.

Note that when each fixed point (reference point) vibrates, an error increases.

When installing each accelerometer 53, it is desirable to check in advance that the vibration level is sufficiently low.

The processing device 20c corrects the data related to the displacement of the measurement target 40 as follows.

First, the displacement [dx, dy] of each fixed point is calculated from the acceleration.

Each fixed point appears to vibrate in the image measurement also due to the influence of the vibration of the camera 13.

When the camera 13 vibrates with six degrees of freedom [X] of [x, y, z, θx, θy, θz], each point appears to vibrate.

The actual vibration at a point set as each fixed point and the sensitivity to the influence of the vibration of the camera 13 are measured or calculated in advance, and a 6×2 matrix [M] is calculated (also considering the influence in the depth direction).

The vibration of the camera 13 can be expressed by the following equation from the vibration [x, y] of each fixed point.

$$[ x , y ] = [ M ] [ X ] + [ dx , dy ]$$

Thus, the vibration of the camera 13 can be estimated from the measurement result of each fixed point by the following equation.

$$[ X ] = [ M ] - 1 [ x - dy , y - dy ]$$

This is performed at one point or a plurality of points.

When the number of points is plural, [X] does not completely match, but [X] is derived by the least squares method or the like so that an error is minimized.

By using [M] at the measurement target position and the vibration [X] of the camera 13 for removal from the measurement result of the measurement target 40, the influence of the vibration of the camera 13 can be removed.

In the present embodiment, the data of the measurement target is also corrected by calculating the relative displacement between each fixed point and the measurement target, in a manner similar to the sixth embodiment. Thus, the influence of the camera vibration can be removed, and the measurement accuracy of the vibration can be improved.

Further, even when each fixed point vibrates, the influence of the camera vibration can be removed.

### Ninth Embodiment

### Configuration of Moving Image Data Acquisition System

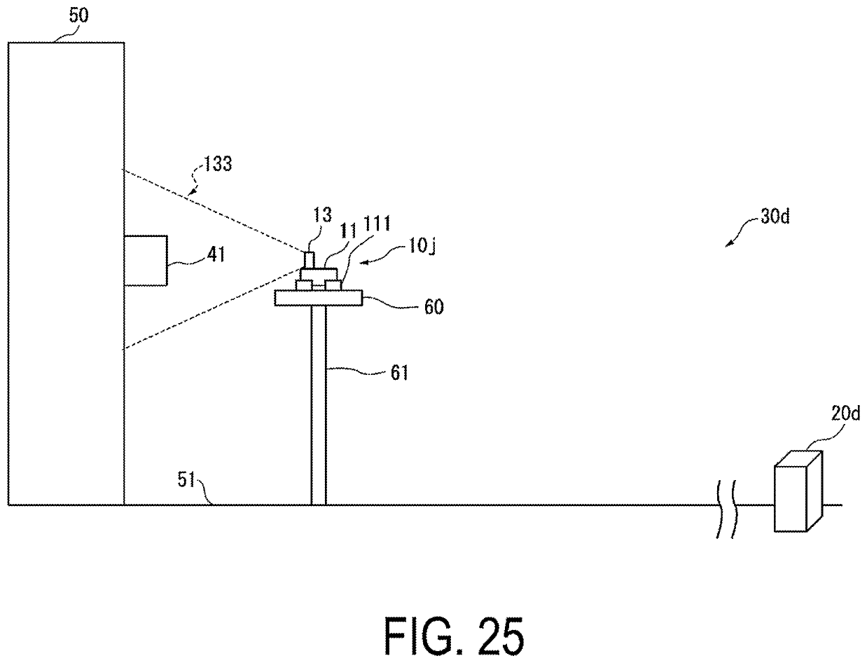

Hereinafter, a moving image data acquisition device, a moving image data acquisition system, and a vibration measurement method according to a ninth embodiment of the present disclosure will be described with reference to FIGS. 25 to 29.

FIG. 25 is a schematic diagram illustrating a configuration example of the moving image data acquisition system according to the ninth embodiment of the present disclosure.

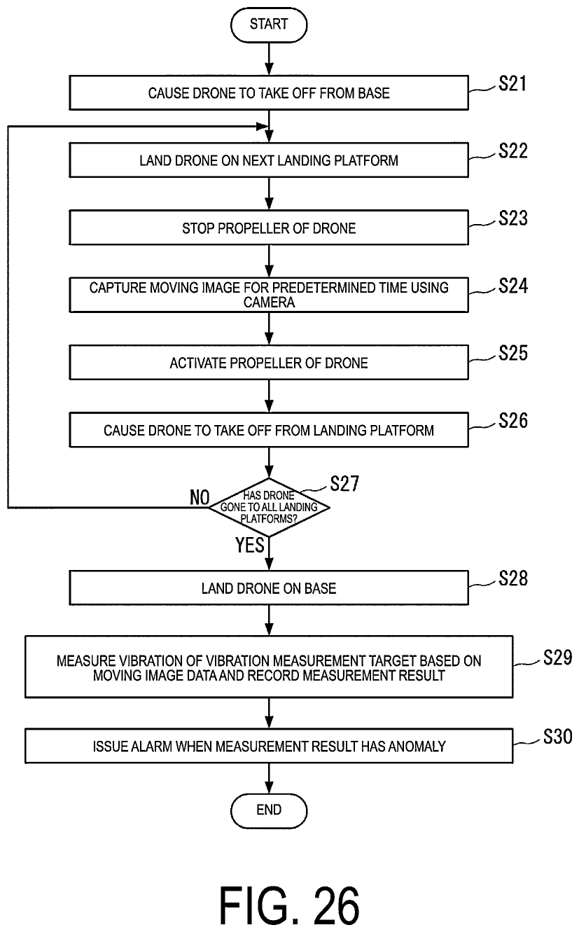

FIG. 26 is a flowchart illustrating an operation example of the moving image data acquisition system according to the ninth embodiment of the present disclosure.

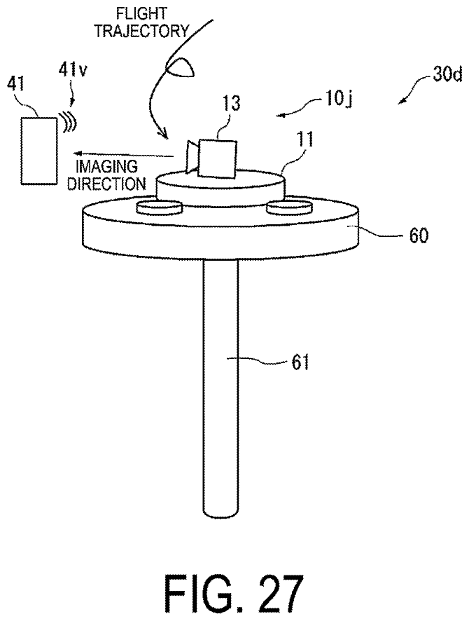

FIG. 27 is a schematic diagram for describing the moving image data acquisition system according to the ninth embodiment of the present disclosure.

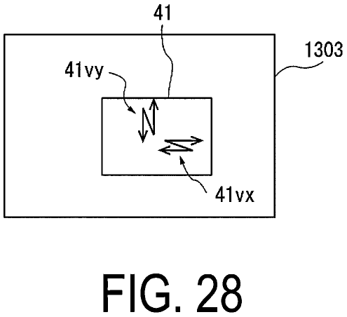

FIG. 28 is a schematic diagram illustrating an example of an image captured by the moving image data acquisition device according to the ninth embodiment of the present disclosure.

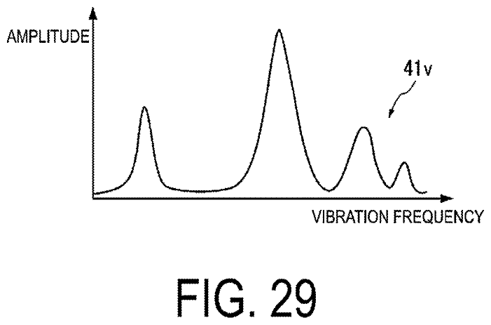

FIG. 29 is a schematic diagram showing an example of frequency characteristics of a vibration measured based on a moving image captured by the moving image data acquisition system according to the ninth embodiment of the present disclosure.

A moving image data acquisition system 30d illustrated in FIG. 25 includes a moving image data acquisition device 10j, a control device 20d, and one or a plurality of landing platforms 60.

The moving image data acquisition system 30d illustrated in FIG. 25 measures the vibration of a vibration measurement target 41 based on moving image data acquired by the moving image data acquisition device 10j and including the vibration measurement target 41 as a subject.

The vibration measurement target 41 is a target of the vibration measurement based on the moving image data.

The vibration measurement target 41 is, for example, an object the weight of which is supported on or which is installed on a ground, a foundation, or the like, wherein the vibration of the object, which is changed due to aging deterioration, accidental anomaly, or the like, can be measured from the appearance. Alternatively, the vibration measurement target 41 is, for example, a certain peripheral region including the object.

The vibration measurement target 41 is, for example, a structure such as a building or a bridge, a machine serving as an excitation source such as a compressor, a pump, a motor, or a fan in a plant, a peripheral object vibrated, accompanied by the excitation source, or the like.

However, the vibration measurement target 41 is not limited to these examples.

The moving image data acquisition device 10j includes a drone 11 and a camera 13.

The drone 11 is an unmanned aerial vehicle, includes a motor, a propeller 111, a control device, an imaging device, a wireless communication device, and the like, and flies by remote control or automatic control.

In the present embodiment, driving of the drone 11 is controlled by the control device 20d.

The drone 11 is equipped with the camera 13.

Note that the moving image data acquisition device 10j (the drone 11 or the camera 13) may have some or all of the functions of the control device 20d described below.

The camera 13 is an imaging device that captures and records a moving image.

The camera 13 includes an optical system such as a lens, an imaging element, a signal processing device, a recording device, a communication device, and the like.

The camera 13 may further include an adjustment mechanism of an imaging direction (or a rotation mechanism), a distance measuring device, and the like.

In this case, it is desirable that the adjustment mechanism (or the rotation mechanism) can be remotely operated.

The imaging operation of the camera 13 can be remotely controlled by the control device 20d.

The camera 13 records a captured moving image in the recording device or transmits the captured moving image to the control device 20d using the communication device.

Note that the camera 13 may be a monocular camera or a compound-eye camera such as a stereo camera.

The camera 13 may include a plurality of monocular cameras or the like having a fixed positional relationship.

The imaging direction of the camera 13 may be one direction, a plurality of directions, or all directions.

The camera 13 may be a visible-light camera, an infrared camera, or the like.

The camera 13 may be configured using, for example, a mobile terminal having a camera function.

In addition, the camera 13 may have a function of measuring the distance to the vibration measurement target 41 based on a captured image or using a distance measuring device or the like and recording the distance in association with the moving image.

Note that the moving image data acquisition device 10j may also perform measurement as a stereo camera by operating a plurality of drones 11 each equipped with one camera 13 as illustrated in FIG. 37, or may perform measurement as a stereo camera by operating one drone 11 equipped with a plurality of cameras 13 as illustrated in FIG. 38.

The control device 20d has a function of controlling the driving of the drone 11 and a function of controlling the imaging operation of the camera 13, in addition to the function related to the vibration measurement of the processing device 20 of the first embodiment described above.

The control device 20d performs a step of landing the drone 11 on the landing platform 60, a step of stopping the propeller 111 of the drone 11, and a step of capturing a moving image for a predetermined time using the camera 13.

Here, the propeller 111 is an example of a flight drive unit of the present disclosure.

However, the flight drive unit is not limited to the propeller 111, and includes, for example, all vibration sources, such as a motor and a fan, that are mounted on the drone 11 and that can be stopped.

The landing platform 60 is a platform on which the drone 11 can be landed.

The landing platform 60 is disposed such that the vibration measurement target 41 is included in a coverage area 133 of the camera 13 when the drone 11 is landed.

The vibration measurement target 41 is, for example, a vibration measurement target installed on the structural body 50.

The vibration measurement target 41 corresponds to the measurement target 40 of the first embodiment.

In the example illustrated in FIG. 25, the landing platform 60 is supported by a strut 61 installed on a foundation 51.

However, the landing platform 60 is not limited to this example, and, for example, may be supported by a support member installed on a ceiling or a wall, or may be configured as a movable and fixable conveyance platform.

Further, the landing platform 60 may be in a horizontal position, or may be inclined so that, for example, the vibration measurement target 41 is easily imaged.

Alternatively, the landing platform 60 may have a structure capable of adjusting the inclination.

The shape of the landing platform 60 is not limited.

The landing platform 60 may have a function of charging a battery of the drone 11 while the moving image data acquisition device 10j (drone 11) is landed.

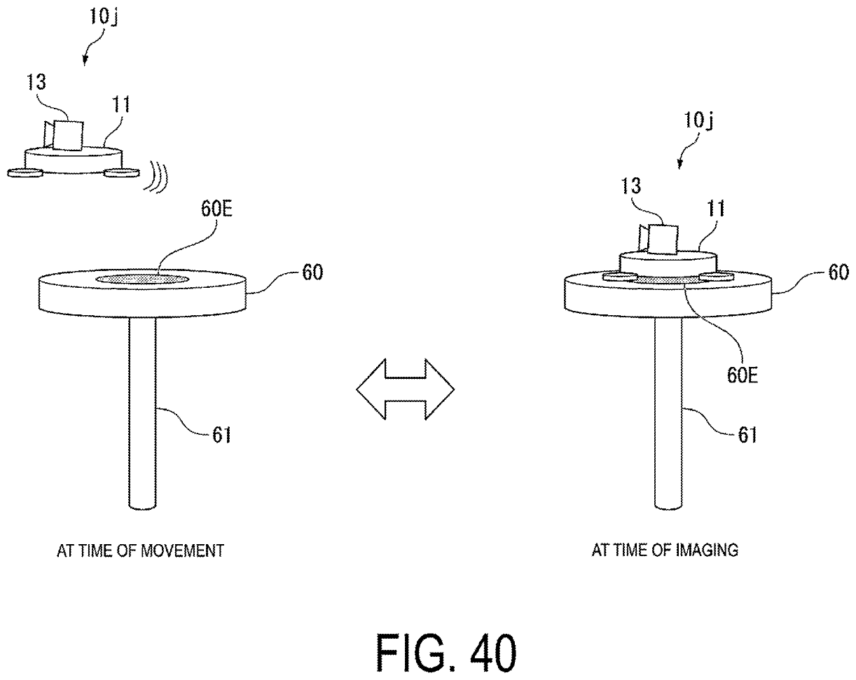

The specific configuration is as illustrated in FIG. 40.

The landing platform 60 according to the present embodiment includes a built-in charging device 60E using a wireless power supply technology.

When the moving image data acquisition device 10j is not landed (the left diagram in FIG. 40), the charging device 60E is in a state of waiting for the landing of the moving image data acquisition device 10j through a signal of a landing sensor (not illustrated).

When the moving image data acquisition device 10j is landed (the right diagram in FIG. 40), the charging device 60E senses the landing of the moving image data acquisition device 10j and then starts charging by wireless power feeding.

With the above configuration, when the image measurement is performed using the landing platform 60, the moving image data acquisition device 10j can be charged during the measurement through the charging function (wireless charging) of the landing platform 60.

This makes it possible to supply power to be used for the image measurement. Thus, even when it takes a long time to perform the image measurement or a large amount of power is consumed through the image measurement, the image measurement can be performed.

Here, power necessary for the moving image data acquisition device 10j to perform the measurement is also used for the transfer of the recorded moving image data and the like, in addition to the recording processing of the moving image.

In addition, it is necessary to secure power necessary for the moving image data acquisition device 10j to fly at the time of returning.

Thus, it is assumed that the moving image cannot be captured as requested unless the battery of the drone 11 is sufficiently charged.

On the other hand, as illustrated in FIG. 40, when the landing platform 60 includes the built-in charging device 60E, power can be supplied through the charging device 60E while the moving image data acquisition device 10j is capturing the moving image.

This prevents the time for capturing the moving image from being limited to leave power necessary for the transfer of the moving image data or the power necessary for flight at the time of returning.

### Operation Example of Moving Image Data Acquisition System

Next, an operation example of the moving image data acquisition system 30d will be described with reference to FIG. 26.

The operation example illustrated in FIG. 26 is an operation of periodically inspecting a plurality of vibration measurement targets 41 using the moving image data acquisition system 30d.

The moving image data acquisition system 30d includes a plurality of landing platforms 60 corresponding to the plurality of different vibration measurement targets 41.

Note that, in the following description, it is assumed that the processing of each of steps S21 to S28 is performed under control of the control device 20d.

However, no such limitation is intended, and all or some of the processing operations of steps S21 to S28 may be programmed in advance in the drone 11.

The processing illustrated in FIG. 26 is periodically performed.

In the processing illustrated in FIG. 26, the control device 20d first causes the drone 11 to take off from a base (step S21).

The base is a place where the drone 11 takes off and is landed at the time of starting and ending the periodic inspection.

Note that the base may be the landing platform 60.

Next, the control device 20d lands the drone 11 on the next (first) landing platform 60 (step S22).

As illustrated in FIG. 27, it is desirable to control the landing state of the drone 11 such that the same screen can be captured at the same angle every time the drone 11 is landed.

Next, the control device 20d stops the propeller 111 of the drone 11 (step S23).

Next, the control device 20d captures a moving image for a predetermined time using the camera 13 (step S24).

Next, the control device 20d activates the propeller 111 of the drone 11 (step S25).

Next, the control device 20d causes the drone 11 to take off from the landing platform 60 (step S26).

Next, the control device 20d determines whether the drone 11 has gone to all the landing platforms 60 (step S27).

When the drone 11 has not gone to all the landing platforms 60 (NO in step S27), the control device 20d lands the drone 11 on the next landing platform 60 (step S22).

When the drone 11 has gone to all the landing platforms 60 (YES in step S27), the control device 20d lands the drone 11 on the base (step S28).

Next, the control device 20d measures the vibration of each vibration measurement target 41 based on the moving image data captured by the camera 13, and records a measurement result (step S29).

As illustrated in FIG. 28, as to moving image data 1303, for example, information indicating a vibration such as vibration components 41vx and 41vy corresponding to a vibration 41v (FIG. 27) of each vibration measurement target 41 is included in a plurality of frames of the moving image data.

For example, as illustrated in FIG. 29, the control device 20d measures each frequency component of the vibration.

FIG. 29 schematically shows an example of the vibration measurement result of each vibration measurement target 41. In FIG. 29, the horizontal axis represents the vibration frequency, and the vertical axis represents the amplitude.

Next, when the measurement result has an anomaly, the control device 20d issues an alarm (step S30).

In the determination of the presence or absence of anomaly, for example, when there is a large difference in an RMS (effective value), a maximum peak value, a vibration frequency of a vibration peak, or the like in an entire band or a narrow band as compared with the previous data, it can be determined that there may be a vibration anomaly.

Note that the control device 20d may further output a contour diagram or the like in which the color tone of a largely vibrating portion is changed.

Alternatively, the control device 20d may issue an alarm by comparing such a portion with the previous measurement data, outputting the ratio of the difference in a list or the like, and coloring a portion having a large difference red on the screen or in the list.

Alternatively, the control device 20d can issue an alarm by changing the display form when there is a portion having a large difference from the previous data on the screen of the analysis result.

Note that, for comparison with the previous data, it is desirable to perform the inspection at the time when the operating state is the same as that of the previous data.

In addition, for example, if programmed, the drone 11 can adjust its direction, position, and the like at the time of landing according to the program using a sensor included in the drone 11.

Alternatively, it may be possible to perform fine adjustment, such as the drone 11 being landed on the landing platform 60 while facing the target, by using the camera 13 or further installing a landing camera on a lower portion of the drone 11, and the adjustment may be performed through remote operation.

Note that, in the processing illustrated in FIG. 26, the processing of steps S28 to S30 is performed after the drone 11 has gone to all the landing platforms 60, but no such limitation is intended.

For example, between the processing of step S24 and the processing of step S25, the same processing as steps S28 to S30 may be performed for each landing platform 60.

### Action and Effect

As described above, according to the present embodiment, the moving image is captured in a state in which the drone 11 is landed on the landing platform 60. The landing platform 60 is disposed such that the vibration measurement target 41 is included in the coverage area 133 of the camera 13 when the drone 11 is landed.

Thus, the camera 13 can capture the moving image in a state where the drone 11 is stopped.

Thus, the vibration can be appropriately measured based on the moving image captured by the camera 13.

Further, according to the present embodiment, for example, a landing place of the drone 11 suitable for periodic inspection is provided at each inspection point, and the drone 11 for the inspection can periodically fly and be landed to acquire data.

At this time, the drone 11 sequentially goes to each inspection point to acquire data, and whether the vibration is larger than the previous inspection result can be checked.

In addition, when there is a large difference in an RMS, a maximum peak value, a vibration frequency of a vibration peak, or the like in an entire band or a narrow band as compared with the previous data, it can be determined that there may be a vibration anomaly.

According to the present embodiment, for example, it is possible to construct a system in which all operations from the drone operation to analysis are automated and an alarm is issued only in an operation causing an anomaly.

### Tenth Embodiment

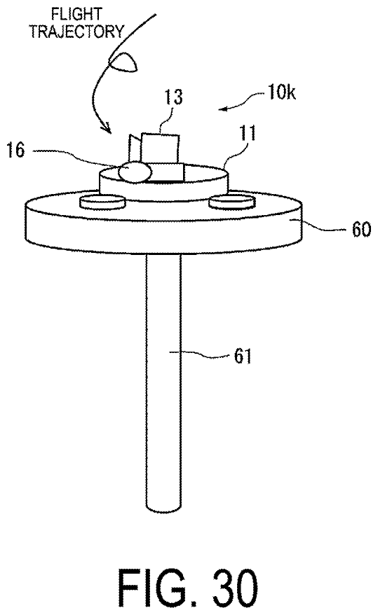

Next, a moving image data acquisition device according to a tenth embodiment of the present disclosure will be described with reference to FIG. 30.

FIG. 30 is a schematic diagram illustrating a configuration example of the moving image data acquisition device according to the tenth embodiment of the present disclosure.

A moving image data acquisition device 10k of the present embodiment illustrated in FIG. 30 differs from the moving image data acquisition device 10j of the ninth embodiment illustrated in FIG. 27 in the following points.

That is, the moving image data acquisition device 10k of the present embodiment further includes a sound measurement microphone 16.

The sound measurement microphone 16 desirably has characteristics suitable for sound measurement of a frequency band or the like, for example.

A sound waveform measured by the sound measurement microphone 16 can be recorded by, for example, the camera 13 so as to be included in moving image data.

The moving image data acquisition system according to the tenth embodiment using the moving image data acquisition device 10k basically has the same configuration as the moving image data acquisition system 30d according to the ninth embodiment illustrated in FIG. 25.

However, in the control device of the tenth embodiment (the configuration corresponding to the control device 20d of FIG. 25), the sound data is also collected at the same time, and the presence or absence of a vibration anomaly is determined from both the vibration in the image and the sound.

The control device of the tenth embodiment analyzes, for example, the sound pressure of the sound measured by the sound measurement microphone 16.

In addition, according to the present embodiment, for example, when the peak frequency of the sound and the peak frequency of the vibration are compared and are the same, a vibration countermeasure can be also used as a noise countermeasure such as reducing a noise level.

In addition, in the case of an anomaly of a vibration frequency higher than a vibration frequency region that can be measured based on an image, there is a case where the anomaly can be measured and determined only based on sound.

### Eleventh Embodiment

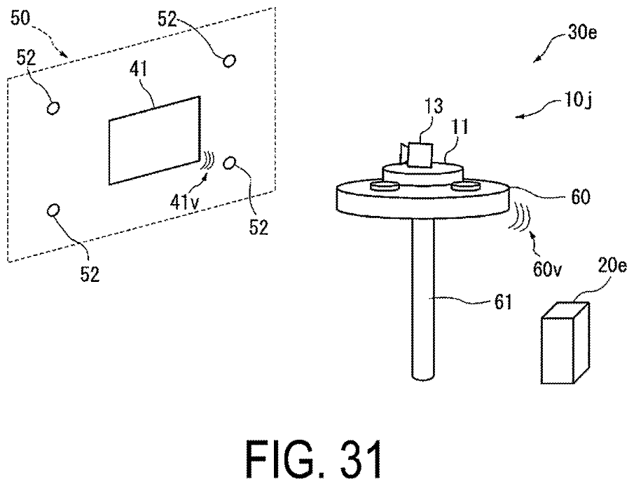

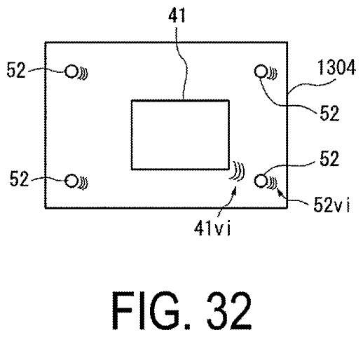

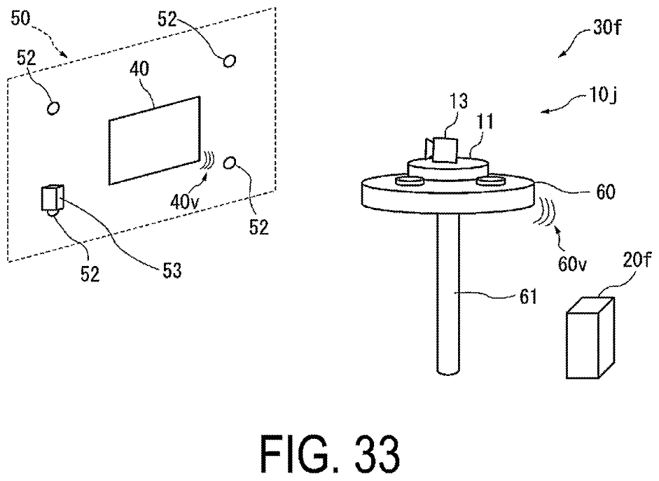

A moving image data acquisition device, a moving image data acquisition system, and a vibration measurement method according to an eleventh embodiment of the present disclosure will be described with reference to FIGS. 31 and 32.

FIG. 31 is a schematic diagram illustrating a configuration example of each of the moving image data acquisition system according to the eleventh embodiment of the present disclosure and a moving image data acquisition system according to a twelfth embodiment of the present disclosure.

FIG. 32 is a schematic diagram illustrating an example of an image captured by each of the moving image data acquisition device according to the eleventh embodiment of the present disclosure and a moving image data acquisition device according to the twelfth embodiments of the present disclosure.

The eleventh embodiment is characterized in that the measurement accuracy of the vibration measurement in the ninth embodiment is improved.

In the eleventh embodiment, for example, a point that can be regarded as a fixed point is set in image data, data of a measurement target is corrected by calculating the relative displacement between the fixed point and the measurement target, and the influence of a camera vibration is removed.

A moving image data acquisition system 30e illustrated in FIG. 31 includes a moving image data acquisition device 10j, a control device 20e, and one or a plurality of landing platforms 60 (not illustrated).

The control device 20e corresponds to the control device 20d illustrated in FIG. 25.

The moving image data acquisition system 30e illustrated in FIG. 31 measures the vibration of a vibration measurement target 41 based on moving image data acquired by the moving image data acquisition device 10j and including the vibration measurement target 41 and fixed points 52 as subjects.

At this time, the control device 20e calculates data related to the displacement of one or a plurality of the fixed points 52 based on the moving image data.

Further, the control device 20e calculates data related to the displacement of the vibration measurement target 41 based on the moving image data.

In addition, the control device 20e corrects the data related to the displacement of the vibration measurement target 41 with the data related to the displacement of the one or plurality of fixed points 52.

Here, the data related to the displacement is data such as the displacement, velocity, and acceleration of the vibration included in the vibration measurement result.

Each fixed point 52 is a point or a region on an object that can be regarded as being fixed.

The expression “ . . . can be regarded as being fixed” means that the object vibrates only to an extent that can be ignored for ensuring of required accuracy in measurement of a vibration 41v of the vibration measurement target 41.

Each fixed point 52 can be, for example, a pillar, a ground, a floor pattern, or a white line away from the vibration measurement target 41 in a factory.

Each fixed point 52 may be set around the vibration measurement target 41 by a person in advance, may be selected and set on the image by a person viewing the moving image data, or may be automatically set by the control device 20e from the moving image data.

In the case of automatic setting, for example, the control device 20e randomly extracts a plurality of feature points from the moving image data and measures vibrations.

Next, the control device 20e relatively compares the measured vibrations.

Then, for example, when there are a plurality of feature points that are not included in the vibration measurement target 41 and that have similar vibrations, the control device 20e can set some or all of the feature points as fixed points.

FIG. 32 illustrates an example of moving image data 1304 in the present embodiment. The moving image data 1304 is acquired by the moving image data acquisition device 10j and includes the vibration measurement target 41 and the fixed points 52 as subjects.

The moving image data 1304 includes information corresponding to a vibration 41vi, which is a vibration 41v of the vibration measurement target 41 including a noise component, and a vibration 52vi of each fixed point 52 due to the noise component.

The vibration 52vi of each fixed point 52 due to the noise component corresponds to, for example, the vibration of the camera 13 through the vibration from a foundation 51.

That is, each fixed point 52 appears to vibrate in the image measurement due to the influence of the vibration of the camera 13.

In the present embodiment, the control device 20e corrects data related to the displacement of the vibration measurement target 41 with data related to the displacement of each fixed point 52 as follows.

The influence of the vibration of the camera 13 is removed from the measurement result [x1, y1] of the vibration measurement target 41 using the vibration [x, y] of each fixed point (reference point).

The measurement result of the measurement target from which the influence of the camera vibration has been removed is defined as [x2, y2].

$$[ x 2 , y 2 ] = [ x 1 - x , y 1 - y ]$$

When the number of the fixed points is one, the above equation is satisfied. However, when the number of the fixed points is plural, the calculation is performed for each fixed point, and the results are slightly different (the results do not completely match because of an error).

In this case, the calculation is performed using the average value so that the error is minimized.

Alternatively, when the depth positions of each fixed point and the measurement target are significantly different from each other, a depth error also occurs. Thus, the position of each fixed point is corrected such that the depth positions of the measurement target and each fixed point are substantially the same.

As described above, according to the present embodiment, the data of the measurement target is corrected by calculating the relative displacement between each fixed point and the measurement target. Thus, the influence of the camera vibration can be removed, and the measurement accuracy of the vibration can be improved.

### Twelfth Embodiment

A moving image data acquisition device, a moving image data acquisition system, and a vibration measurement method according to a twelfth embodiment of the present disclosure will be described.

The twelfth embodiment is partially different from the eleventh embodiment in the content of vibration correction processing.

That is, in the present embodiment, a control device 20e corrects data related to the displacement of a vibration measurement target 41 with data related to the displacement of fixed points 52 as follows.

As described above, each fixed point (reference point) appears to vibrate in image measurement due to the influence of the vibration of the camera 13.

The camera 13 vibrates with six degrees of freedom [X] of [x, y, z, θx, θy, θz], and thus each fixed point appears to vibrate similarly.

The relationship of the displacement of each fixed point with respect to the vibration of the camera 13 is measured or calculated in advance, and a 6×2 matrix [M] is calculated (considering the influence in the depth direction).

The vibration of the camera 13 can be expressed by the following equation from the vibration [x, y] of each fixed point.

[x,y]′=[M][X]

Thus, the vibration of the camera itself can be estimated from the measurement result of each fixed point by the following equation.

$$[ X ] = [ M ] - 1 [ x , y ] ’$$

This is performed at one point or a plurality of points.

When the number of points is plural, [X] does not completely match, but [X] is derived by the least squares method or the like so that an error is minimized.

By using [M] at the position of the measurement target and the vibration [X] of the camera for removal from the measurement result of the measurement target, the influence of the vibration of the camera can be removed.

In the present embodiment, the data of the measurement target is also corrected by calculating the relative displacement between each fixed point and the measurement target, in a manner similar to the eleventh embodiment. Thus, the influence of the camera vibration can be removed, and the measurement accuracy of the vibration can be improved.

### Thirteenth Embodiment

A moving image data acquisition device, a moving image data acquisition system, and a vibration measurement method according to a thirteenth embodiment of the present disclosure will be described with reference to FIG. 33.

The thirteenth embodiment is different from the eleventh embodiment in that an accelerometer 53 is installed at a fixed point 52 as illustrated in FIG. 33 and in the content of processing in which a control device 20f corrects data related to the displacement of a vibration measurement target 41 with data related to the displacement of the fixed point 52.

The control device 20f performs a step of correcting the data related to the displacement of the vibration measurement target 41 with the data related to the displacement of the fixed point and acceleration data measured by the accelerometer 53 at the fixed point 52.

As illustrated in FIG. 33, a moving image data acquisition system 30f of the present embodiment includes a moving image data acquisition device 10j, a control device 20f, and one or a plurality of accelerometers 53.

The one or plurality of accelerometers 53 may be installed at one or a plurality of fixed points 52.

The acceleration data measured by the one or plurality of accelerometers 53 is recorded in, for example, a predetermined recording device in the control device 20f in a state where the acceleration data can be synchronized with moving image data acquired by the moving image data acquisition device 10j.

Note that when each fixed point (reference point) vibrates, an error increases.

When installing each accelerometer 53, it is desirable to check in advance that the vibration level is sufficiently low.

The control device 20f corrects the data related to the displacement of the vibration measurement target 41 as follows.

First, the displacement [dx, dy] of each fixed point is calculated from the acceleration.

Each fixed point appears to vibrate in the image measurement also due to the influence of the vibration of the camera 13.

When the camera 13 vibrates with six degrees of freedom [X] of [x, y, z, θx, θy, θz], each point appears to vibrate.

The actual vibration at a point set as each fixed point and the sensitivity to the influence of the vibration of the camera 13 are measured or calculated in advance, and a 6×2 matrix [M] is calculated (also considering the influence in the depth direction).

The vibration of the camera 13 can be expressed by the following equation from the vibration [x, y] of each fixed point.

$$[ x , y ] = [ M ] [ X ] + [ dx , dy ]$$

Thus, the vibration of the camera 13 can be estimated from the measurement result of each fixed point by the following equation.

$$[ X ] = [ M ] - 1 [ x - dy , y - dy ]$$

This is performed at one point or a plurality of points.

When the number of points is plural, [X] does not completely match, but [X] is derived by the least squares method or the like so that an error is minimized.

By using [M] at the measurement target position and the vibration [X] of the camera 13 for removal from the measurement result of the vibration measurement target 41, the influence of the vibration of the camera 13 can be removed.

In the present embodiment, the data of the measurement target is also corrected by calculating the relative displacement between each fixed point and the measurement target, in a manner similar to the eleventh embodiment. Thus, the influence of the camera vibration can be removed, and the measurement accuracy of the vibration can be improved.

Further, even when each fixed point vibrates, the influence of the camera vibration can be removed.

### Other Embodiments

Although the embodiments of the present disclosure have been described in detail with reference to the drawings, specific configurations are not limited to the embodiments and also include design modifications, and the like without departing from the gist of the present disclosure.

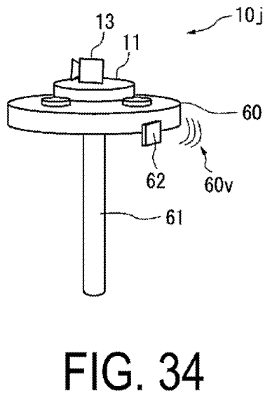

For example, in the ninth to thirteenth embodiments, an accelerometer 62 may be provided at the landing platform 60 as illustrated in FIG. 34, the vibration acceleration of the landing platform 60 itself may be measured at the time of vibration measurement, and correction processing of removing the vibration from the image of the camera 13 may be performed.

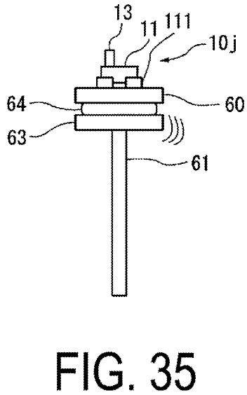

Alternatively, for example, in the ninth to thirteenth embodiments, a pedestal 63 and a vibration isolation unit 64 may be provided between the landing platform 60 and the strut 61 as illustrated in FIG. 35.

The vibration isolation unit 64 is a vibration isolation device or a vibration-proof rubber, and significantly reduces the vibration of the landing platform 60.

Note that FIGS. 34 and 35 are schematic diagrams for describing modification examples of the moving image data acquisition system according to each of the ninth to thirteenth embodiments of the present disclosure.

### Computer Configuration

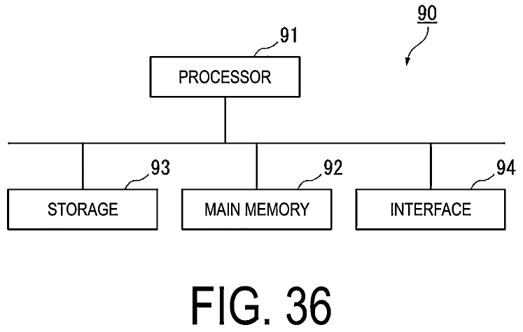

FIG. 36 is a schematic block diagram illustrating a configuration of a computer according to at least one embodiment.

The computer 90 includes a processor 91, a main memory 92, a storage 93, and an interface 94.

The processing devices 20, 20a, 20b, and 20c and the control devices 20d, 20e, and 20f described above are implemented in the computer 90.

The operation of each processing unit described above is stored in the storage 93 in the form of a program.

The processor 91 reads the program from the storage 93, develops the program in the main memory 92, and performs the above-described processing according to the program.

In addition, the processor 91 allocates a storage area corresponding to each storage unit described above in the main memory 92 according to the program.

The program may be for implementing some of the functions exerted by the computer 90.

For example, the program may exert the functions in combination with another program already stored in the storage or in combination with another program installed in another device.

Note that, in another embodiment, the computer may include a custom large scale integrated circuit (LSI) such as a programmable logic device (PLD) in addition to or instead of the above configuration.

Examples of the PLD include a programmable array logic (PAL), a generic array logic (GAL), a complex programmable logic device (CPLD), and a field programmable gate array (FPGA).

In this case, some or all of the functions implemented by the processor may be implemented by the integrated circuit.

Examples of the storage 93 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory.

The storage 93 may be an internal medium directly connected to a bus of the computer 90, or may be an external medium connected to the computer 90 via the interface 94 or a communication line.

In addition, when the program is distributed to the computer 90 through a communication line, the computer 90 that has received the distributed program may develop the program in the main memory 92 and perform the above-described processing.

In at least one embodiment, the storage 93 is a non-transitory tangible storage medium.

### Notes

The embodiments described above are understood as follows, for example.

(1) Moving image data acquisition devices 10, 10a, 10b, 10c, 10d1, 10d2, 10e, 10f, 10g, 10h, and 10i according to a first aspect include a camera 13, a support (drone 11, 11a, rod-like member 11b1, wire winding device 11b2) that supports the camera 13, and a coupling member (spring 12, wire 12a, 12b) that couples the support and the camera 13, wherein the coupling member has a natural vibration frequency in a vibration frequency region lower than a vibration frequency region serving as a measurement target for vibration measurement using moving image data acquired by the camera.

According to the present aspect and each of the following aspects, it is possible to appropriately measure a vibration based on a moving image captured by a camera.

(2) Moving image data acquisition devices 10, 10a, 10b, and 10c according to a second aspect are the moving image data acquisition devices according to (1), wherein the support is an unmanned aerial vehicle (drone 11, 11a), and the coupling member is a spring (spring 12) having a spring constant adjusted such that the spring has a natural vibration frequency in a vibration frequency region lower than the vibration frequency region serving as the measurement target.

(3) Moving image data acquisition devices 10d1, 10d2, 10e, 10f, 10g, 10h, and 10i according to a third aspect are the moving image data acquisition devices according to (1), wherein the support is a rod-like member 11b1 configured to be held by a person or a wire winding device 11b2 fixed to a structural body, and the coupling member is a wire 12a, 12b having a length adjusted such that the wire has a natural vibration frequency in a vibration frequency region lower than the vibration frequency region serving as the measurement target.

(4) Moving image data acquisition devices 10a, 10b, and 10c according to a fourth aspect are the moving image data acquisition devices according to (2), wherein the support (drone 11a) includes a windbreak tube 14, and the camera 13 is supported such that the camera is located in the windbreak tube.

(5) Moving image data acquisition devices 10a, 10b, and 10c according to a fifth aspect are the moving image data acquisition devices according to (4), wherein the windbreak tube 14 includes a hole 140 through which a lens 132 of the camera 13 passes, and the camera 13 is supported such that the lens 132 is located outside the windbreak tube through the hole 140.

(6) Moving image data acquisition devices 10a, 10b, and 10c according to a sixth aspect are the moving image data acquisition devices according to (4) or (5), wherein the camera 13 and an inner wall of the windbreak tube 14 are connected by one or a plurality of connection members 141 to 144 having a natural vibration frequency in a vibration frequency region lower than the vibration frequency region serving as the measurement target.

(7) A measurement method according to a sixth aspect includes calculating (S12) data related to displacement of one or a plurality of fixed points 52 based on moving image data acquired by each of the moving image data acquisition devices according to (1) to (6), calculating (S13) data related to displacement of the measurement target based on the moving image data, and correcting (S14) the data related to the displacement of the measurement target with the data related to the displacement of the one or plurality of fixed points.

(8) A measurement method according to an eighth aspect includes calculating data related to displacement of one or a plurality of fixed points 52 based on moving image data acquired by each of the moving image data acquisition devices according to any one of (1) to (6), calculating data related to displacement of the measurement target based on the moving image data, and correcting the data related to the displacement of the measurement target with the data related to the displacement of the one or plurality of fixed points and acceleration data measured at the one or plurality of fixed points.

(9) Moving image data acquisition systems 30d, 30e, and 30f according to a ninth aspect include an unmanned aerial vehicle (drone 11) equipped with a camera 13, and a landing platform 60 on which the unmanned aerial vehicle is capable of being landed, wherein the landing platform is disposed such that a vibration measurement target 41 is included in a coverage area 133 of the camera when the unmanned aerial vehicle is landed.

(10) Moving image data acquisition systems 30d, 30e, and 30f according to a tenth aspect are the moving image data acquisition systems according to (9), further including control device 20d, 20e, and 20f configured to control driving of the unmanned aerial vehicle, wherein each control device performs landing (S22) the unmanned aerial vehicle on the landing platform, stopping (S23) a flight drive unit of the unmanned aerial vehicle, and capturing (S24) a moving image for a predetermined time using the camera.

(11) A vibration measurement method according to an eleventh aspect includes calculating data related to displacement of one or a plurality of fixed points 52 based on moving image data acquired by each of the moving image data acquisition systems 30e and 30f according to (9) or (10), calculating data related to displacement of the vibration measurement target 41 based on the moving image data, and correcting the data related to the displacement of the vibration measurement target 41 with the data related to the displacement of the one or plurality of fixed points 52.

(12) A vibration measurement method according to a twelfth aspect includes calculating data related to displacement of one or a plurality of fixed points 52 based on moving image data acquired by the moving image data acquisition system 30f according to (9) or (10), calculating data related to displacement of the vibration measurement target 41 based on the moving image data, and correcting the data related to the displacement of the vibration measurement target 41 with the data related to the displacement of the one or plurality of fixed points 52 and acceleration data measured at the one or plurality of fixed points.

### INDUSTRIAL APPLICABILITY

According to each aspect of the present invention, it is possible to appropriately measure a vibration based on a moving image captured by a camera.

### REFERENCE SIGNS LIST

10, 10a, 10b, 10c, 10d1, 10d2, 10e, 10f, 10g, 10h, 10i, 10j, 10k Moving image data acquisition device
11, 11a Drone
11b1 Rod-like member
11b2 Wire winding device
12 Spring
12a, 12b Wire
13 Camera
14 Windbreak tube
30, 30a, 30b, 30c, 30d, 30e, 30f Moving image data acquisition system
40 Measurement target
41 Vibration measurement target
52 Fixed point
60 Landing platform
132 Lens
140 Hole
141 to 144 Connection member

1. A moving image data acquisition device comprising:
a camera;
a support that supports the camera; and
a coupling member that couples the support and the camera, wherein
the coupling member has a natural vibration frequency in a vibration frequency region lower than a vibration frequency region serving as a measurement target for vibration measurement using moving image data acquired by the camera.

2. The moving image data acquisition device according to claim 1, wherein
the support is an unmanned aerial vehicle, and
the coupling member is a spring having a spring constant adjusted such that the spring has a natural vibration frequency in a vibration frequency region lower than the vibration frequency region serving as the measurement target.

3. The moving image data acquisition device according to claim 1, wherein
the support is a rod-like member configured to be held by a person or a wire winding device fixed to a structural body, and
the coupling member is a wire having a length adjusted such that the wire has a natural vibration frequency in a vibration frequency region lower than the vibration frequency region serving as the measurement target.

4. The moving image data acquisition device according to claim 2, wherein
the support includes a windbreak tube, and
the camera is supported such that the camera is located in the windbreak tube.

5. The moving image data acquisition device according to claim 4, wherein
the windbreak tube includes a hole through which a lens of the camera passes, and
the camera is supported such that the lens passes through the hole and is located outside the windbreak tube.

6. The moving image data acquisition device according to claim 4, wherein
the camera and an inner wall of the windbreak tube are connected by one or a plurality of connection members having a natural vibration frequency in a vibration frequency region lower than the vibration frequency region serving as the measurement target.

7. A vibration measurement method comprising:
calculating data related to displacement of one or a plurality of fixed points based on moving image data acquired by the moving image data acquisition device according to claim 1;
calculating data related to displacement of the measurement target based on the moving image data; and
correcting the data related to the displacement of the measurement target with the data related to the displacement of the one or plurality of fixed points.

8. A vibration measurement method comprising:
calculating data related to displacement of one or a plurality of fixed points based on moving image data acquired by the moving image data acquisition device according to claim 1;
calculating data related to displacement of the measurement target based on the moving image data; and
correcting the data related to the displacement of the measurement target with the data related to the displacement of the one or plurality of fixed points and acceleration data measured at the one or plurality of fixed points.

9. A moving image data acquisition system comprising:
an unmanned aerial vehicle equipped with a camera; and
a landing platform on which the unmanned aerial vehicle is capable of being landed, wherein
the landing platform is disposed such that a vibration measurement target is included in a coverage area of the camera when the unmanned aerial vehicle is landed.

10. The moving image data acquisition system according to claim 9, further comprising:
a control device that controls driving of the unmanned aerial vehicle, wherein
the control device performs:
landing the unmanned aerial vehicle on the landing platform;
stopping a flight drive unit of the unmanned aerial vehicle; and
capturing a moving image for a predetermined time using the camera.

11. A vibration measurement method comprising:
calculating data related to displacement of one or a plurality of fixed points based on moving image data acquired by the moving image data acquisition system according to claim 9;
calculating data related to displacement of the vibration measurement target based on the moving image data; and
correcting the data related to the displacement of the vibration measurement target with the data related to the displacement of the one or plurality of fixed points.

12. A vibration measurement method comprising:
calculating data related to displacement of one or a plurality of fixed points based on moving image data acquired by the moving image data acquisition system according to claim 9;
calculating data related to displacement of the vibration measurement target based on the moving image data; and
correcting the data related to the displacement of the vibration measurement target with the data related to the displacement of the one or plurality of fixed points and acceleration data measured at the one or plurality of fixed points.
